(19) United States
(12) Patent Application Publication
(10) Pub. No.: US 2004/0069350 A1
(43) Pub. Date: Apr. 15, 2004

(54) Vacuum demand flow valve

(76) Inventors: Hal C. Danby, Chilton (GB); Julian Swan, Ealing (GB); Mark E. Williamson, Wonder Lake, IL (US)

Correspondence Address: Francis C. Kowalik, Esq., Corporate Counsel, Law Department, BAXTER INTERNATIONAL INC., One Baxter Parkway, DF3-2E, Deerfield, IL, 60015, US

(21) Appl. No.: 10/414,413

(22) Filed: Apr. 14, 2003

Related U.S. Application Data
(63) Continuation-in-part of application No. 10/096,083, filed on Mar. 12, 2002.

(51) Int. Cl. F16K 31/12

(52) U.S. Cl. 137/510

(57) ABSTRACT

A valve is disclosed for dispensing a flowable material. The valve has a first chamber (40) at a first pressure wherein said first chamber (40) defines an outlet (28) in communication with said first chamber (40). A second chamber (42) is at a second pressure. The valve has a stop (18) indexed against a third pressure, operating to selectively place the first chamber (40) into communication with the second chamber (42). The stop (18) is operative to connect the second chamber (42) to said first chamber (40) when the first pressure is less than the third pressure. The valve includes a vent (520) for venting the second chamber (42) when flowable material is removed.

### RELATED APPLICATIONS

The present application is a continuation-in-part application of U.S. Continuation-In-Part Application No. 10/096,083, filed on Mar. 12, 2002 and entitled “Vaccum Demand Flow Valve,” which is expressly incorporated herein by reference.

### TECHNICAL FIELD

The present invention relates generally to valves used in conjunction with fluid containers or tubing, and more specifically to a valve having a vent associated with a fluid container and being actuated by a vacuum.

### BACKGROUND PRIOR ART

Fluid containers are widely used throughout the world and come in many forms. Such fluid containers are made from a variety of materials and are used for numerous purposes. For example, containers are commonly used to contain fluids such as water, soft drinks, sports drinks, alcoholic beverages and the like for individual consumer use and consumption. Fluid containers are also widely used in other applications such as in a medical setting. For example, fluid containers are used in hospitals to provide nutritional fluids to patients who cannot eat solid food. Also fluid containers contain a variety of material used in industry and various mechanical arts such as engines and the like.

A drawback to using such containers is the contents of the container can be easily spilled and, therefore, wasted. Not only are the contents lost but fluid spills can damage the surface the fluid contacts. Spilling of fluid contents is a particularly common occurrence for patients in a hospital setting. The patients can be under sedation or other medication that causes drowsiness or disorientation. The patients can also often drift into an involuntary unconscious state while consuming the nutritional products. This can result in spillage of the nutritional product over the patients' bedding requiring changing of the bedding and cleaning of the spillage. FIG. 1 shows a variety of settings where fluid spills can occur. For example, fluids contained in drink pouches or drink boxes popular with children can be spilled through the straw supplied with the containers. Additionally, one is familiar with the problems arising with fluid spills in an industrial setting, wherein the spill of a caustic or dangerous chemical causes significant clean-up expense as well as placing workers in a potentially hazardous position.

Some fluid containers may be supplied with a closure such as a threaded cap. Such closures, however, normally must be open and/or closed manually by hand. This makes it difficult for consumers to use during certain activities such as running or cycling, or if consumers are carrying several other items that cannot be put down. Other closures have been developed that can be automatically actuated but are difficult to use. Such containers are also not economical to manufacture to be used with disposable fluid containers.

The present invention is provided to solve these and other problems.

### SUMMARY OF THE INVENTION

The present invention provides a vacuum demand flow valve capable of dispensing a flowable material. In one preferred embodiment, the vacuum demand flow valve is attached to a drink container.

According to one aspect of the invention, a valve includes a member subject to a first force operative to keep said valve closed, said member being sensitive to an index pressure. An outlet is at a second pressure, said index pressure providing a second force in opposition to said first force when a differential between said second pressure and said index pressure is provided to said member, and opening the valve when said second pressure is sufficiently less than the index pressure to overcome the first force. A vent is operably associated with the valve to maintain a fluid container to which the valve is operably connected at a pressure at least substantially equal to the index pressure.

According to another aspect of the present invention, a valve includes a housing defining a passageway between an outlet opening and an inner opening, and a member being deflectable from a first position to a second position associated with the housing. A stop is connected to the deflectable member, wherein when the deflectable member is in the first position, the stop is in sealing contact with the inner opening to close the inner opening, and when the deflectable member is in the second position, the stop is spaced from the inner opening to open the inner opening. A vent is operably associated with the stop where the vent comprises a vent passageway and a vent member.

According to another aspect of the present invention, a flowable material delivery device includes a first chamber under ambient pressure, the first chamber defining an outlet. A second chamber containing a reservoir of flowable material which is vented to maintain the second chamber at a pressure at least substantially equal to ambient pressure. An opening connecting the first chamber and the second chamber. A deflectable member is positioned in the opening between said first chamber and said second chamber and moveable from a closed position to an open position when a pressure less than ambient pressure is applied to the first chamber wherein the flowable material flows from the second chamber through the outlet.

Other features and advantages of the invention will be apparent from the following specification taken in conjunction with the following drawings.

### BRIEF DESCRIPTION OF THE DRAWINGS

FIG. 1 shows a plurality of schematic views illustrating problems encountered with prior art fluid containers;

FIG. 2 is a perspective view of a vacuum demand flow valve of the present invention attached to a flexible fluid container;

FIG. 3 is a perspective view of the container of FIG. 2 showing removal of a tamper evident strip;

FIG. 4 is a perspective view of the valve and container wherein a cap of the valve is removed;

FIG. 5 is a partial cross-sectional view of the valve and container, the valve being shown in a closed position;

FIG. 6 is a partial cross-sectional view of the valve and container, the valve being placed in an open position by a user;

FIG. 7 is a partial cross-sectional view of the valve and container, the valve returned to a closed position;

FIG. 8 is a schematic view of the valve of the present invention; and

FIG. 9 is a partial cross-sectional view of the valve and container, the valve adapted to be placed in an open position via a syringe;

FIG. 10 is an exploded perspective view of another embodiment of the vacuum demand flow valve of the present invention;

FIG. 11 is a partial cross-sectional view of another embodiment of the vacuum demand flow valve of the present invention and the container, the valve being shown in a closed position;

FIG. 12 is a partial cross-sectional view of the valve and container of FIG. 11, the valve being placed in an open position by a user;

FIG. 13 is a partial cross-sectional view of the valve and container of FIG. 11, the valve returned to a closed position;

FIGS. 14a-d are cross-sectional views showing assembly of the valve of FIG. 10;

FIG. 15 is an exploded perspective view of another embodiment of the vacuum demand flow valve of the present invention;

FIG. 16 is a cross-sectional view of the valve of FIG. 15, the valve being shown in a closed position;

FIGS. 17a-c are cross-sectional views showing assembly of the valve of FIG. 15;

FIG. 18 is an exploded perspective view of another embodiment of the vacuum demand flow valve of the present invention;

FIG. 19 is a cross-sectional view of the valve of FIG. 18, the valve being shown in a closed position;

FIGS. 20a-d are cross-sectional views showing assembly of the valve of FIG. 18;

FIG. 21 is a perspective view of another embodiment of the vacuum demand flow valve of the present invention attached to a flexible fluid container;

FIG. 22 is a partial perspective view of the container of FIG. 21 showing removal of a tamper evident strip;

FIG. 23 is a perspective view of the valve and container wherein a cap of the valve is removed;

FIG. 24 is a partial cross-sectional view of the valve and container of FIG. 21, the valve being shown in a closed position;

FIG. 25 is a partial cross-sectional view of the valve and container of FIG. 21, the valve being placed in an open position by a user;

FIG. 26 is a schematic view of a user consuming a fluid from a container having a vacuum demand flow valve of the present invention;

FIG. 27 is perspective view of a vacuum demand flow valve of the present invention attached to a fluid container, the valve having an indicia-bearing surface;

FIG. 28 is a perspective view of another vacuum demand flow valve of the present invention attached to a fluid container, the valve having an indicia-bearing surface;

FIGS. 29a-c are schematic views showing various uses of the vacuum demand flow valve of the present invention;

FIG. 30 is a schematic view showing another use of the vacuum demand flow valve of the present invention;

FIG. 31 is a schematic view showing another use of the vacuum demand flow valve of the present invention;

FIG. 32 is a schematic view showing another use of the vacuum demand flow valve of the present invention;

FIGS. 33a-b are schematic views showing additional uses of the vacuum demand flow valve of the present invention;

FIGS. 34a-d are schematic views showing additional uses of the vacuum demand flow valve of the present invention;

FIG. 35 is a schematic view showing another use of the vacuum demand flow valve of the present invention; and

FIGS. 36a-b are schematic views showing additional uses of the vacuum demand flow valve of the present invention.

FIG. 37 is a perspective view of another embodiment of the vacuum demand flow valve of the present invention, the valve attached to a fluid container;

FIG. 38 is a rear elevation view of the vacuum demand flow valve of FIG. 37;

FIG. 39 is a plan view of the vacuum demand flow valve of FIG. 37;

FIG. 40 is a side elevation view of the vacuum demand flow valve of FIG. 37;

FIG. 41 is an exploded perspective view of the vacuum demand flow valve of FIG. 37;

FIG. 42 is a cross-sectional view of the vacuum demand flow valve of FIG. 37;

FIG. 43 is a cross-sectional view of the vacuum demand flow valve with attached container showing the valve in a closed position;

FIG. 44 is a cross-sectional view of the vacuum demand flow valve with attached container showing the valve placed in an open position by a user;

FIG. 45 is a cross-sectional view of another embodiment of the vacuum demand flow valve having a modified stop member, the valve shown in a closed position;

FIG. 46 is a cross-sectional view of the vacuum demand flow valve of FIG. 45 showing the valve placed in an open position by a user; and

FIG. 47 is a cross-sectional view of the vacuum demand flow valve of FIG. 37 with attached container and having the modified stop member of FIG. 45, the valve being placed in an open position by a user.

FIG. 48 is a schematic diagram of alternative embodiments of the valve of FIG. 37;

FIG. 49 is an exploded perspective view of another embodiment of the valve of the present invention;

FIG. 50 is an exploded perspective view of another embodiment of the valve of the present invention;

FIG. 51 is a perspective view of another embodiment of the valve of the present invention having a cap thereon;

FIG. 52 is a schematic view of the valve of FIG. 51 having the cap removed;

FIG. 53 is a cross-sectional view of another embodiment of the valve of the present invention having a vent;

FIG. 54 is a cross-sectional view of the valve of FIG. 53 attached to a fluid container;

FIG. 55 is a cross-sectional view of the valve of FIG. 53 wherein the vent is in a closed position;

FIG. 56 is a cross sectional view of the valve of FIG. 53 as it appears during use;

FIG. 57 is a cross-sectional view of the valve of FIG. 53 wherein the vent is in an open position

FIG. 58 is a cross-sectional view of the valve of FIG. 53 attached to a fluid container having indented sides;

FIG. 59 is another cross-sectional view of the valve of FIG. 53 attached to a fluid container;

FIG. 60 is a cross-sectional view of another embodiment of the valve of the present invention having a vent;

FIG. 61 is a cross-sectional view of the valve of FIG. 60 wherein the vent is in a closed position;

FIG. 62 is a cross-sectional view of the valve of FIG. 60 wherein the vent is in an open position;

FIG. 63 is a cross-sectional view of the valve of FIG. 60 as it appears during use;

FIG. 64 is a cross-sectional view of the valve of FIG. 60 attached to a fluid container having indented sides;

FIG. 65 is a cross-sectional view of the valve of FIG. 60 attached to a fluid container;

FIG. 66 is a cross-sectional view of another embodiment of the valve of the present invention having a vent;

FIG. 67 is a cross-sectional view of the valve of FIG. 66 wherein the vent is in a closed position;

FIG. 68 is a cross-sectional view of the valve of FIG. 66 wherein the vent is in an open position;

FIG. 69 is a cross-sectional view of the valve of FIG. 66 as it appears during use;

FIG. 70 is a cross-sectional view of the valve of FIG. 66 attached to a fluid container having indented sides; and

FIG. 71 is a cross-sectional view of the valve of FIG. 66 attached to a fluid container.

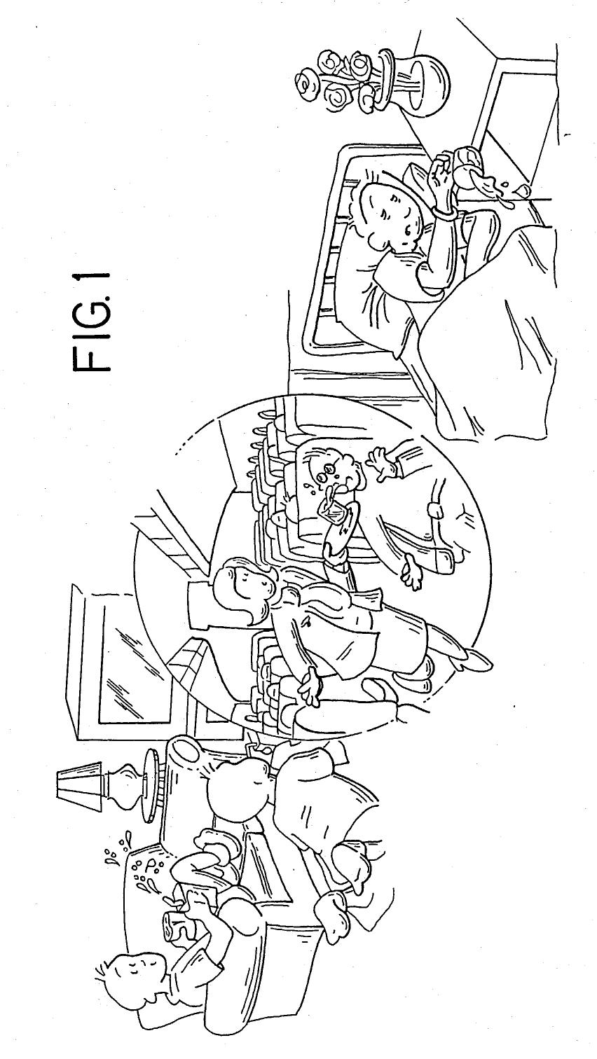

### DETAILED DESCRIPTION

While this invention is susceptible to embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

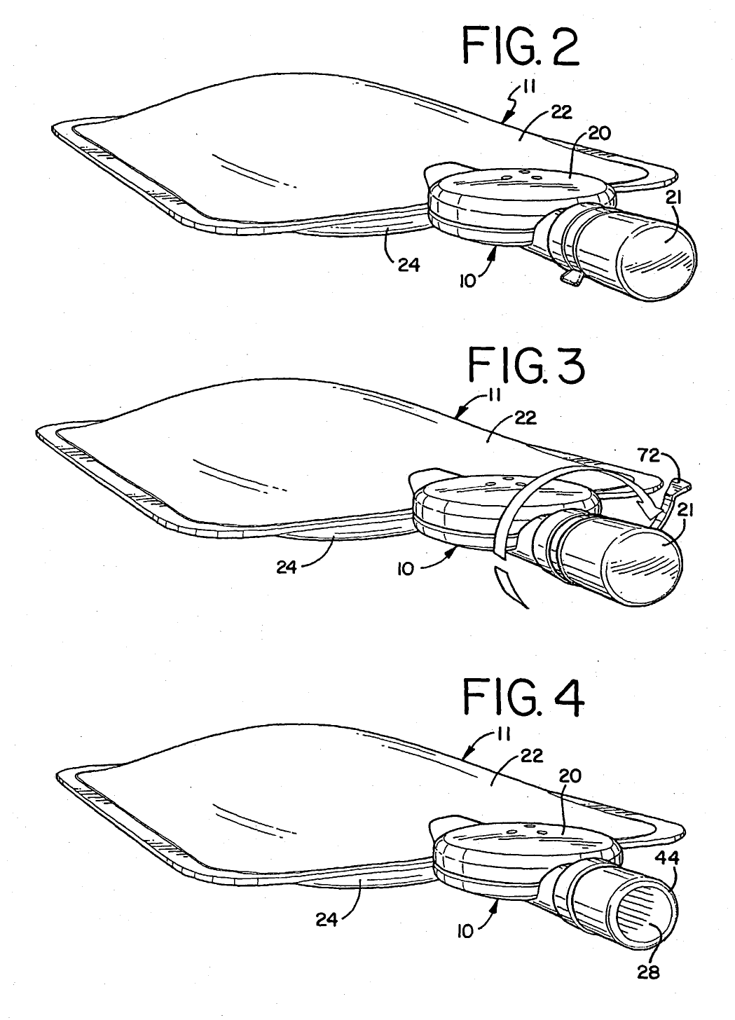

FIG. 2 discloses a vacuum demand flow valve, generally referred to with the reference numeral 10, attached to a flexible fluid container 11. It is understood that the valve 10 can be used with various types of containers that contain a flowable material or substance. Thus, the shape of the container 11 can be arbitrary. The structure of the valve 10 will first be described followed by a description of the operation of the valve 10. Other embodiments of the valve will also be described.

As shown in FIGS. 2-7, the valve 10 generally includes a housing 12. The valve 10 also includes a diaphragm 14, a stop 18, and a radially extensive plug 70 which, can be considered in combination to be a valve member. Similarly, equivalent valve members shall be subsequently shown in other embodiments of the instant invention having differing reference numerals. Also shown is a diaphragm cover 20 and a cap 21. The valve 10 is adapted to be connected to the container 11. The container 11 may be formed as to have a first sidewall 22 and a second sidewall 24. The valve 10 allows for dispensing flowable materials from the container 11. The container 11 defines a reservoir for holding flowable materials. As discussed in greater detail below, the diaphragm member 14 is a flexible member that can be actuated by a user through the use of a vacuum pressure or a positive, external force.

As shown in FIG. 5, the housing 12 has a generally tubular structure defining a passageway 26 for a flowable material to pass therethrough. The housing 12 has a first opening 28 defining a valve outlet and a second opening 30, or inlet opening 30 adapted to be in communication with the container 11. The passageway 26 is between the valve outlet 28 and the inlet opening 30. The housing 12 further generally has an upper wall 32 and a lower wall 34. The walls 32,34 of the housing 12 cooperatively define a first housing section 36 and a second housing section 38. The first section 36 defines a first chamber 40 and the second section 38 defines a second chamber 42. In certain embodiments, the passageway 26 can only comprise the first chamber 40. The first section 36 has a port member 44 that has one end defining the first opening 28 of the housing 12. The port member 44 is generally a tubular structure and is sized such that, in an embodiment that is adapted to be useable by a person directly, a user's mouth can fit comfortably over the port member 44. Thus, the port member 44 can be considered a mouthpiece for the user. In an embodiment that is adapted to be used in conjunction with a pump or a syringe, an appropriately shaped port member would be supplied. The port member 44 also has an orifice 46 having a lesser diameter than the remainder of the passageway 26. This will be described in greater detail below. The orifice 46 could comprise a plurality of orifices. It is understood that the nomenclature of the first and second sections and chambers can be reversed.

The housing 12 further has an internal, or intermediate wall 48 extending between the upper wall 32 and the lower wall 34. The intermediate wall 48 has an inner opening 50. The inner opening 50 can be considered a second opening. The intermediate wall 48 further has an underside surface 52. The intermediate wall 48 generally divides the housing 12 to define the first chamber 40 and the second chamber 42. The first chamber 40 can be considered a downstream side of the valve 10 and the second chamber 42 can be considered an upstream side of the valve. The inner opening 50 will be in communication with the fluid container 11 via the second chamber 42. The second chamber 42 can include the fluid container 11.

The upper wall 32 has a generally circular opening 54 defined by an annular rim 56. The circular opening 54 is adapted to receive the diaphragm 14 to be described in greater detail below. The annular rim 56 has a lip 58. A front portion of the annular rim 56 cooperates with a vertical wall 60 of the port member 44 to define a groove 62.

As further shown in FIG. 5, the diaphragm 14 is a resilient, deflectable member that in one preferred embodiment, is generally circular in shape. The diaphragm 14 has a central portion 64 and an annular peripheral edge 66 defining a flange 68. The diaphragm 14 is connected to the housing 12 and is received by the circular opening 54. The flange 68 cooperates with the lip 58 of the annular rim 56. The diaphragm 14 is slightly under-sized as compared to the annular rim 56 wherein the elastomeric properties of the diaphragm 14 ensure a seal between the diaphragm 14 and the rim 56. Once connected, the diaphragm 14 can be considered a portion of the housing 12 that is flexible and deflectable from a first position to a second position to open the valve 10 as described below as well as being capable of being biased towards the first position due to either the structural properties of the assembly or the mechanical properties of the diaphragm 14. Thus, in a preferred embodiment, the diaphragm 14 comprises the flexible portion of the housing 12.

As also shown in FIG. 5, the stop member 18 is generally a plug member having a flange 70 at one end. The stop member 18 depends from a central portion 64 of the diaphragm 14 and extends through the internal opening 50. The flange 70 abuts the underside 52 of the intermediate wall 48 to define a closed valve position. The flange 70 can be considered a plug that is radially extensive from the stop 18 and sized to close the inner opening 50. The plug, or flange 70 can be considered to be located toward an upstream side of the valve from the stop. The upstream side of the valve can be considered generally at the second chamber 42 and the downstream side of the valve can be generally considered at the first chamber 40. In a preferred embodiment, the stop member 18 and the diaphragm 14 can be integrally molded together so as to form the valve member aforedescribed. As described in greater detail below, the resiliency of the diaphragm 14 biases the stop member 18 against the internal opening 50 to define a closed valve position. The flange 70 abuts the underside surface 52 of the internal wall 48.

In one preferred embodiment, the valve 10 utilizes the diaphragm cover 20. The diaphragm cover 20 is positioned over the diaphragm 14. The diaphragm cover 20 has a collar 65 that fits around the flange 68 of the diaphragm 14. The diaphragm cover 20 can fit within the groove 62 at a front portion of the valve 10. The diaphragm cover 20 is sized to assist in the compression of the diaphragm 14 around the annular rim 56. The diaphragm cover 20 helps protect the valve 10 from accidental activation. As shown in FIGS. 2 and 3, if desired, the valve 10 can also be equipped with the cap 21 that is press-fit over the port member 44. A tamper evident sealing member 72 can also be included. The tamper evident sealing member 72 seals the cap 21 to the housing 12 and gives a visual indication of whether the valve 10 has been tampered with or previously manipulated. It is understood that the valve components can be connected through a variety of processes including radio frequency or ultrasonic welding as well as solvent bonding or other methods as appropriate for the materials used.

As discussed, in one preferred embodiment, the valve 10 is attached to a fluid container 11. The container may either be formed from a single web or may have a flexible first sidewall 22 and flexible second sidewall 24. In the configuration and as shown in FIGS. 2, 3, and 4, the valve 10 is inserted between peripheral edges of the sidewalls 22,24. The upper wall 32 is generally connected to the first sidewall and the lower wall 34 is generally connected to the second sidewall 24.

As shown in FIG. 5, the container 11 is shown in a configuration having a single circumferential sidewall as may be formed by blow molding and the like.

Prior to operation of the valve 10, the cap 21 is secured to the housing 12 by the tamper evident strip 72. As shown in FIGS. 3 and 4, the tamper evident strip 70 is peeled away and the cap 21 removed to expose the port member 44.

FIGS. 5-7 disclose operation of the valve 10. In an initial state, and as shown in FIG. 5, the valve 10 is in a closed position wherein the stop member 18 is biased against the underside surface 52 to close the inner opening 50. The valve member is subject to a first force operative to keep the valve 10 closed. In this first position, the first chamber 40 of the passageway 26 has a first volume V1. An external surface 15 of the diaphragm 14, and therefore the combination of the diaphragm 14, the stop 18, and the flange 70, which in combination can be referred to as a valve member, is generally subject to, and is sensitive to, an index pressure PI. The index pressure could be, for example, ambient pressure with the cap 20 being vented, or some other pressure resident in the interstice between the diaphragm 14 and the cap 20. The valve member is indexed against this index pressure PI. The first chamber 40 is also generally subjected to a pressure P1 which could be approximately equal to or greater than the index pressure PI.

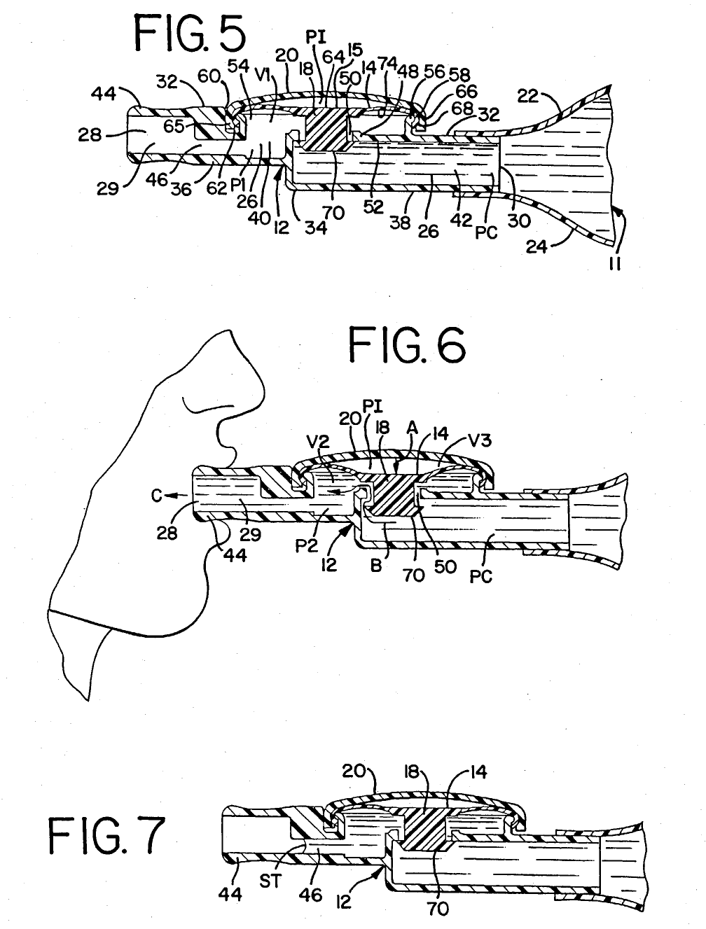

The second chamber 42 and the container 11 may also be at an ambient pressure, or at some pressure substantially at or above the index pressure PI. The pressure in the second chamber 42 and container 11 may be referred to as PC. The pressure in the container 11 will not be substantially less than the pressure in the first chamber 40. As shown in FIG. 6, a user places their mouth over the port member 44 and reduces the pressure through the first chamber 40 of the passageway 26. This reduced pressure can be referred to as P2. The partial vacuum provides a pressure less than the index pressure. As shown in FIG. 6, the vacuum acts on a lower surface 74 of the diaphragm 14 causing the index pressure on the upper surface of the diaphragm to apply a force on the diaphragm 14 equal to the difference between the index pressure and the pressure of the partial vacuum times the area of the diaphragm 14, drawing it downwards. This moves the stop member 18 downwards in the direction of arrow A, and into the second chamber 42 towards the container 11. The flange 70 is spaced away from the inner opening 50 thus opening the valve 10. This occurs when the force applied overcomes a first force associated with the diaphragm 14 that maintains the stop member 18 to close the internal opening 50. This force may be, preferredly, a resilient spring force associated with the diaphragm structure or, in other embodiments, be due to an index pressure substantially below the initial pressure in the first chamber acting on the diaphragm 14; or a force due to pressure in the container 11 acting on the area of plug 70; or may be applied by an external means as exemplified by the spring 164 in FIG. 18. In this second position, the first chamber 40 of the passageway 26 has a second volume V2. The second volume V2 is less than the first volume V1 as the diaphragm 14 is moved closer to the intermediate wall 48. It is also understood the area between the diaphragm 14 and the cover 20 increases to a volume of V3 in this position. In this position, the flowable material such as a drink fluid, as shown, is allowed to flow from the container 11, through the inner opening 50 in the direction of arrow B, through the passageway 26 and out the first opening 28 to be consumed by the user. Thus, when a vacuum is applied, a force is applied to the housing 46 in a first direction (arrow A) in response to the vacuum thereby placing the passageway 48 in the second position, wherein fluid flows through the passageway in a second direction generally shown as arrow C in FIG. 6. Thus, when a differential between the second pressure and the index pressure is provided to the valve member, the valve 10 opens when the second pressure is sufficiently less than the index pressure to overcome the first force operative on the valve member. The container 11 is adapted to supply constant pressure when the valve 10 is open, such as a flexible container 11 or a rigid container having a vent. It is understood the valve 10 is operable even if the container 11 is pressurized.

It can be further understood that the valve member is subject to a first force, as described hereabove, operative to keep the valve 10 closed. The valve member, i.e., the combination of the diaphragm 14, the stop 18, and the flange 70, supplies this biasing force as aforesaid. The valve member is sensitive to the index pressure. The outlet 28 of the valve 10 is subject to a second pressure. The index pressure provides a second force in opposition to the first force when a differential between the second pressure and the index pressure is provided to open the valve such that the second pressure is sufficiently less than the index pressure, multiplied by the area of the valve member, to overcome the first force. As shown in FIG. 6, the vacuum acts on a lower surface 74 of the diaphragm 14 causing the index pressure on the upper surface of the diaphragm to apply a force on the diaphragm 14 equal to the difference between the index pressure and the pressure of the partial vacuum times the area of the diaphragm 14, drawing it downwards. This moves the stop member 18 downwards in the direction of arrow A, and into the second chamber 42 towards the container 11. The flange 70 is spaced away from the inner opening 50 thus opening the valve 10. This occurs when the second pressure is sufficiently less than the index pressure wherein the force applied overcomes the resilient spring force or other sources of the force associated with the diaphragm 14 that biases the stop member 18 to close the internal opening 50.

As shown in FIG. 7, once the vacuum is removed, the valve 10 returns to the first or closed position. Thus, when the second pressure is substantially equal to or greater than the index pressure, the valve 10 closes. The resiliency of the diaphragm 14 biases the stop member 18 against the underside surface 52 of the intermediate wall 48 to close the inner opening 50 and therefore the valve 10. Fluid that passes through the port member 44, after the vacuum has been removed, is consumed by the user. The change between the first volume V1 and the second volume V2 provides for an action that serves to withdraw the fluid from the outlet 28 back into the outlet passageway 29 such that the linear distance the fluid is withdrawn into the outlet passageway 29 is equal to the difference between the volume V2 and the volume V1 divided by the area of the outlet 28 which is sufficient to draw the fluid toward the passageway 26 and away from the outlet 28. Fluid that remains in the passageway 26 at the reduced diameter orifice 46 when the vacuum is removed, however, does not drip from the valve 10. The orifice 46 is sized in the port member 44 such that surface tension ST of the fluid across the orifice 46 maintains the fluid in the passageway 48 once the vacuum is removed. The molecules of the fluid will experience an inward force from the other fluid molecules wherein the fluid will act like an elastic sheet across the orifice 30. Molecules at the edges of the orifice will be attracted to the surfaces of the housing 12 defining the orifice 30. Thus, due to surface tension ST of the fluid, the fluid already in the passageway 26 cannot pass through the orifice 46 until a vacuum is again applied.

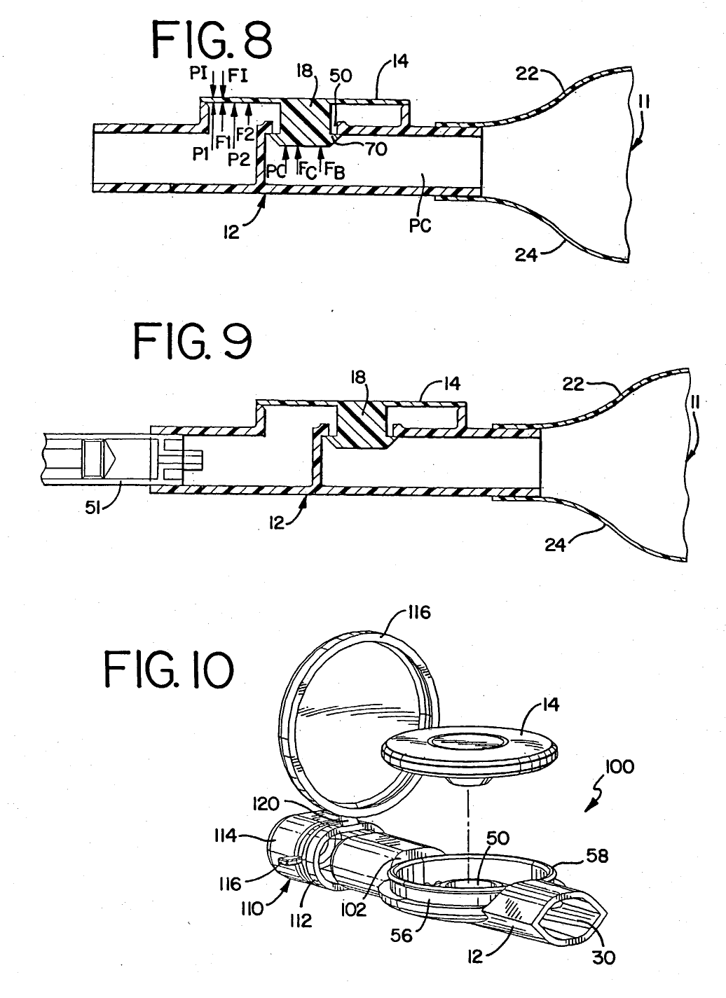

It can be understood that in this valve configuration as disclosed in FIGS. 2-7, the second chamber 42 of the passageway 26 of the valve 10 is in communication with the container 11. The second chamber 42 can include the container 11. The stop member 18 and the inner opening 50 can define a simple valve. In an initial state, the upper surface 15 of the diaphragm 14 is subject to an index pressure PI. In one embodiment, the index pressure PI can be ambient pressure. Also in the initial state, the first chamber 40 of the passageway 26 could also be under some different first pressure P1 or the index pressure PI. The second chamber 42 would be under a second pressure PC which also could typically be ambient pressure. The container 11 is also initially under the container pressure PC. This pressure could be ambient pressure. When a partial vacuum is applied, the first chamber 40 is now under a second pressure P2 that is less than the index pressure PI. In this state, the valve moves from a closed position to an open position wherein the fluid is allowed to flow through the outer opening 50. Thus, the valve operates to selectively place the first chamber 40 into communication with the second chamber 42. Accordingly, a differential pressure is applied across the diaphragm 14 causing the valve 10 to open and allow fluid to pass through the opening 50. In one preferred embodiment, the pressure differential occurs from ambient pressure, wherein the index pressure is at ambient pressure and the housing chamber is subjected to a negative pressure. Thus, the valve 10 is actuated by applying a pressure less than ambient pressure. It is understood that a pressure differential could also be applied from an initial pressure not equal to ambient pressure. One could also consider the index pressure a third pressure wherein the first chamber is subject to a first pressure and the second chamber is subject to a second pressure at least substantially equal to the first pressure. The valve is indexed against the third pressure. The valve operates to selectively place the first chamber into communication with the second chamber when the first pressure is less than the third pressure, or index pressure. FIG. 8 further illustrates the pressures, and forces associated with the pressures, that act on the valve member during operation of the valve 10. The index pressure exerts an index force FI on an outer surface of the diaphragm 14. Prior to operation, the first chamber has a first pressure P1 and a first force F1 acting on an inner surface of the diaphragm 14 serving to balance the remaining forces acting on the valve. The container pressure PC and container force FC also acts on the valve member at the plug 70. A biasing force FB also acts on the valve member and is, in certain embodiments, supplied by the structure of diaphragm 14. When the first pressure P1 is reduced to a new pressure P2, a force F2 (less than F1) is applied to the diaphragm 14. The resultant force acting on the diaphragm 14 to open the valve 10 can be represented by the following vector formula: FR (resultant force)=AD(PI−P2)−AP(PC)−FB wherein AD is the area of the diaphragm 14 and AP is the area of the plug 70.

It is understood that the valve 10 can operate without utilizing the diaphragm cover 20. FIG. 8 discloses a simplified version of the valve 10 wherein a diaphragm cover 20 is not used. The diaphragm 14 can comprise a flexible portion of the housing 12. Upon actuation, this housing portion would flex to move the stop member 18 away from the inner opening 50.

It is further understood that the vacuum to actuate the valve 10 is typically applied by a user reducing the pressure through the passageway 26. The vacuum could also be applied by other means such as a syringe 51 as shown in FIG. 9. A vacuum could also be applied by a pump or other mechanical means. Finally, it is understood that the designations of “first” and “second” with respect to the chambers, pressures and valve positions can be interchanged.

In an alternative method of valve actuation, a user can depress the diaphragm 14 through the cover 20 to move the stop member 18 away from the inner opening 50. Fluid is then allowed to pass through the passageway 26 and out the outer opening 28.

It is understood that the valve 10 can be incorporated into a tubing. A portion of the tubing can be flexible and provide the diaphragm 14. An opposite portion of the tubing can be provided with the opening 50 to be communication with the container 11. The stop member 18 can be provided between the diaphragm 14 and opening 50.

It is further understood that the valve 10 could be constructed with multiple chambers and diaphragms or connected to a manifold designed to be in communication with separate chambers of a multi-chambered container. Different fluids, stored separately, could then be consumed together.

The valve components can be made from a variety of materials. The materials can be selected based on the intended use of the valve 10. In one embodiment, such as the valve being used with drink containers, the valve components can be made from a variety of polymers or other structurally suitable materials. Other materials are also possible. The choice of materials is only related to the fluid and use the valve is to be applied to. For example, should this valve be used in the fuel or oxidizer supply section of a rocket engine with an injection pump providing a partial vacuum and the index pressure externally applied; the valve member and housing may be made out of stainless steel.

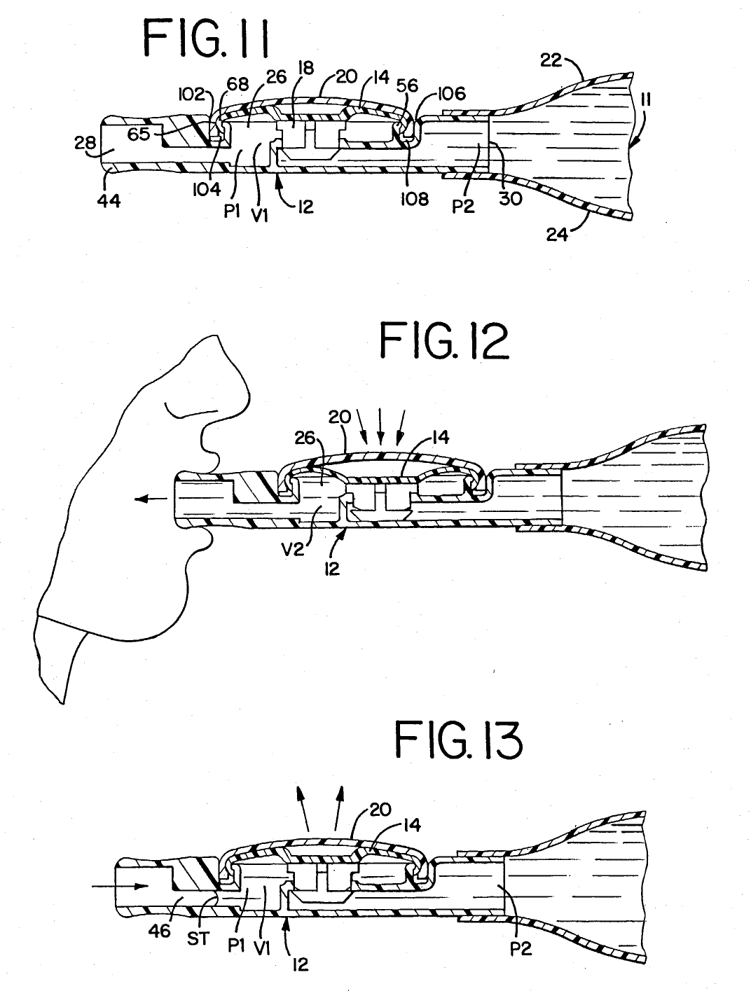

FIGS. 10-14 disclose another embodiment of the vacuum demand flow valve of the present invention, generally referred to with the reference numeral 100. The vacuum demand flow valve 100 is similar to the valve 10 disclosed in FIGS. 2-7 and similar elements will be referred to with identical reference numerals. As shown in FIG. 11, the upper wall 32 of the housing 12 has the generally circular opening 54 defined by the annular rim 56. Proximate a front portion of the housing 12, the upper wall 32 has a first vertical wall 102. The first vertical wall 102 cooperates with the annular rim 56 to define a first groove 104. Proximate a rear portion of the housing 12, the upper wall 32 has a second vertical wall 106. The second vertical wall 106 cooperates with the annular rim 56 to define a second groove 108. As discussed previously, the diaphragm 14 is connected to the annular rim 56 wherein the flange 68 cooperates with the lip 58 of the annular rim 56. The diaphragm cover 20 is positioned over the diaphragm 14 wherein the collar 65 fits around the flange 68 of the diaphragm 14. The diaphragm cover 20 fits snugly within the first groove 104 and the second groove 108. FIG. 12 shows the valve 100 in an open position wherein a partial vacuum has been applied through the passageway 26. It is understood that the stop 18 as shown in FIG. 12 is structured to allow flow through the inner opening 50 and out the outlet opening 28. In FIG. 13, the vacuum has been removed wherein the valve 100 returns to a closed position as discussed above. The fluid is drawn back into the orifice wherein it will not drip out of the valve 100.

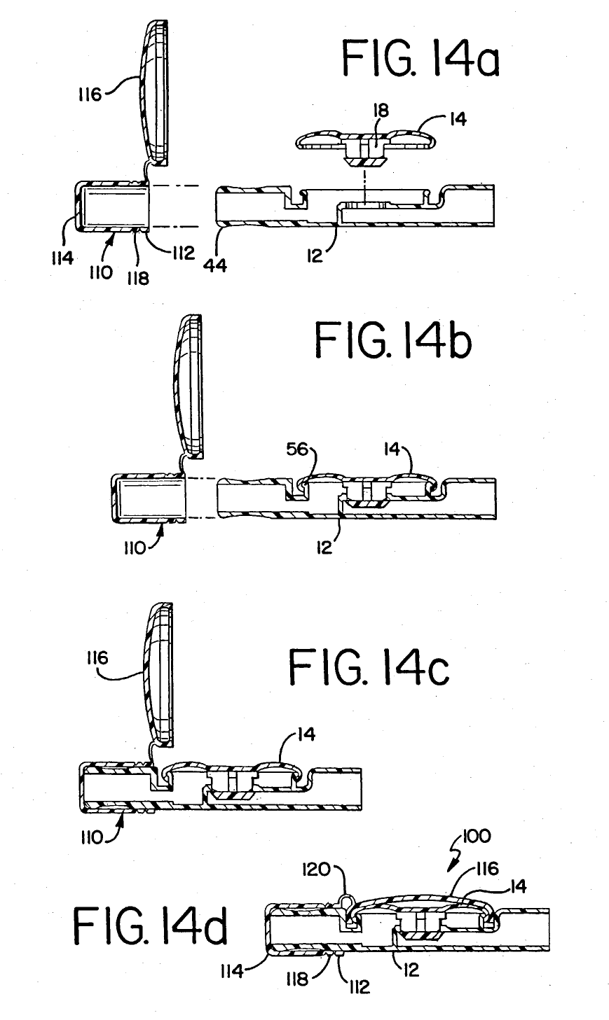

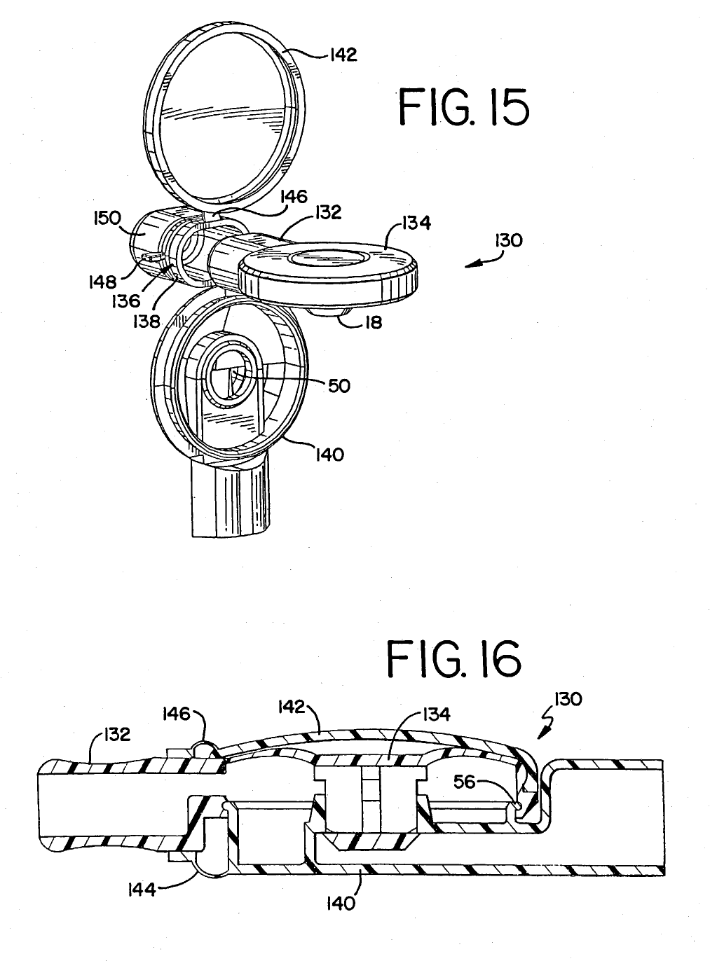

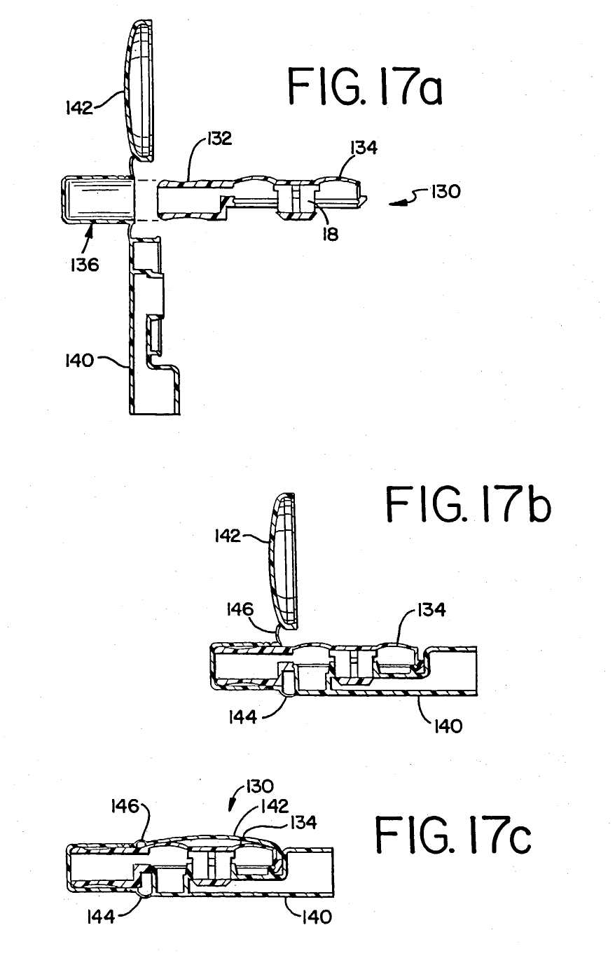

FIGS. 10 and 14 disclose a slightly modified diaphragm cover/cap assembly 110. In this design, the assembly 110 has a collar 112, a cap 114 and a diaphragm cover 116. The collar 112 is connected to the cap 114 by a tamper evident strip 118 similar to the tamper evident strip 72 in FIG. 3. The diaphragm cover 116 is connected to the collar 112 by a flexible strap 120. FIGS. 14a-d disclose a general assembly of the valve 100. The diaphragm 14 is first connected to the housing 12 as discussed above. The cover/cap assembly 110 is then connected to the housing 112. The collar 112 and cap 114 are slid over the port assembly 44 of the housing 12. The diaphragm cover 116 is then pivoted and connected over the diaphragm 14 as shown in FIG. 14d. Prior to operation of the valve 110, the tamper evident strip 118 can be torn away to remove the cap 114 from the collar 112 to expose the port member 44 of the housing 12. The valve 100 is operated as described above.

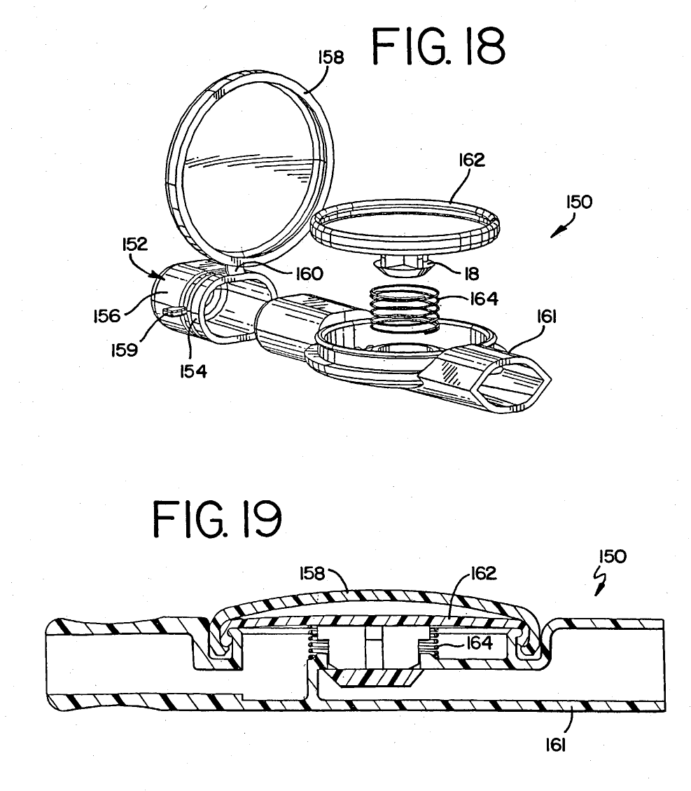

FIGS. 15-17 disclose another embodiment of the vacuum demand valve of the present invention, generally designated with the reference numeral 130. In this embodiment, the port member of the housing is separated and connected instead to the diaphragm member 14. As shown in FIGS. 15 and 16, a port member 132 is integrally connected to a diaphragm 134. A collar assembly 136 is provided having a collar 138, a housing 140 and a diaphragm cover 142. The housing 140 is connected to the collar 138 by a first flexible strap 144. The diaphragm cover 142 is connected to the collar 138 by a second flexible strap 146. The collar assembly 136 also has a tamper evident strip 148 connecting a cap 150 to the collar 138. FIGS. 17a-c disclose a general assembly of the valve 130. The port member 132 is inserted into the collar assembly 136. The housing 140 is pivoted about the first flexible strap 144 wherein the stop member 18 connected to the diaphragm 134 is inserted into the internal opening of the housing 140. The port member 132 and diaphragm 134 are connected to the annular rim 56 on the housing 140. The diaphragm cover 142 is pivoted about the second flexible strap 146 and connected over the diaphragm 134. The valve 130 is operated as described above.

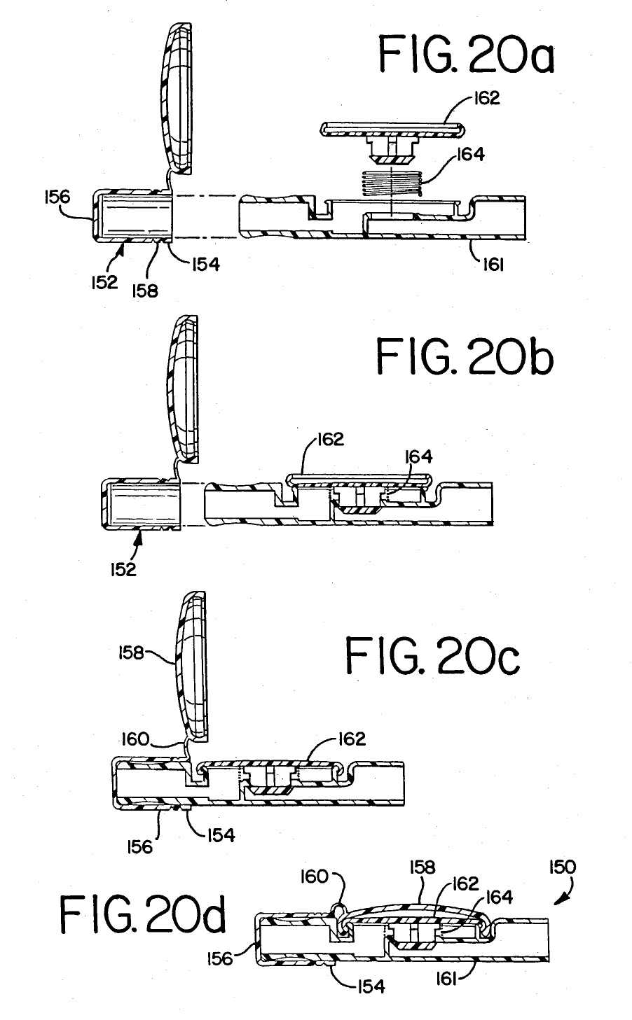

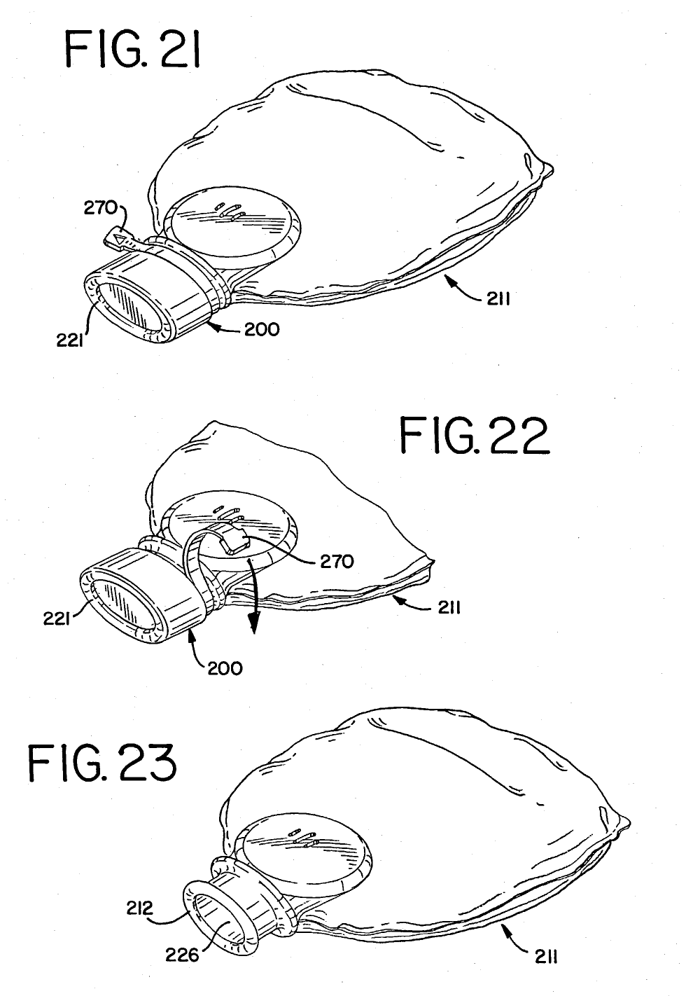

FIGS. 18-20 disclose another embodiment of the vacuum demand valve of the present invention, generally designated with the reference numeral 150. As shown in FIG. 18, the valve 150 has a diaphragm cover/cap assembly 152. In this design, the assembly 152 has a collar 154, a cap 156 and a diaphragm cover 158. The collar 154 is connected to the cap 156 by a tamper evident strip 159 similar to the tamper evident strip 72 in FIG. 3. The diaphragm cover 158 is connected to the collar 154 by a flexible strap 160. The valve 150 utilizes a housing 161 and a diaphragm 162. The diaphragm 162 is biased towards a closed position by a spring 164. The spring 164 is positioned around the stop member 18 wherein one end abuts the intermediate wall of the housing 161 and another end abuts an underside surface of the diaphragm 162. FIGS. 20a-d disclose a general assembly of the valve 150. The spring 164 is on the intermediate wall of the housing 161 and the diaphragm 162 connected to the housing 162 via the annular rim 56. The housing 161 is inserted into the assembly 152 as shown in FIG. 20c. The diaphragm cover 158 is then pivoted via the flexible strap 160 and connected over the diaphragm 162. FIG. 19 shows the valve 150 utilizing a separate diaphragm cover 158 similar to the valve construction shown in FIG. 11. The valve 150 is operated as described above.

FIGS. 21-25 disclose yet another embodiment of the vacuum demand valve of the present invention. This valve, generally referred to with the reference numeral 200, is shown attached to a flexible fluid container 211. It is understood that the valve 200 can be used with various types of containers that contain a flowable material or substance. The structure of the valve 200 will first be described followed by a description of the operation of the valve 200.

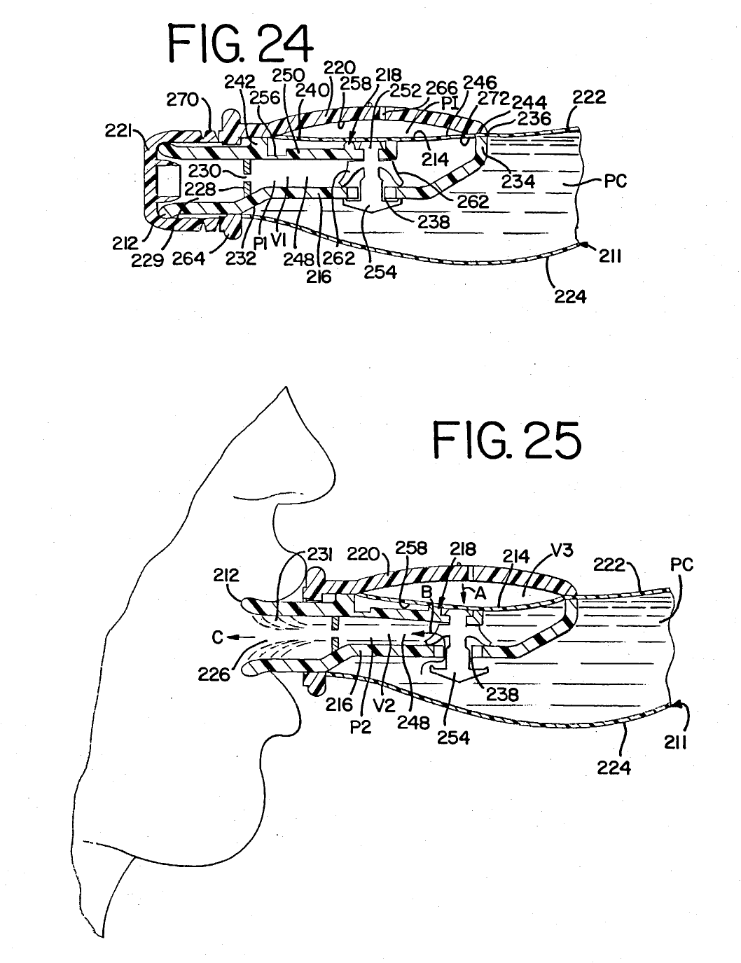

As shown in FIG. 24, the valve 200 generally includes a port member 212, a first member or diaphragm member 214, a second member or base member 216, a stop member 218, a diaphragm cover 220 and a cap 221. The valve 200 is adapted to be connected to the container 211 that has a first sidewall 222 and a second sidewall 224. The valve 200 allows for dispensing flowable materials from the container 211. As discussed in greater detail below, the diaphragm member 214 is a flexible member that can be actuated by a user through the use of a vacuum pressure or a positive, external force.

As further shown in FIGS. 24 and 25, the port member 212 is generally a tubular structure and defines an outlet or outer opening 226. The port member 212 is sized such that a user's mouth can fit comfortably over the port member 212. In one preferred embodiment as shown in FIG. 23, the port member 212 has an elliptical shape. The port member 212 has a disk-shaped member 228 having an orifice 230 (FIG. 24).

The base member 216 is an elongated member that extends from a bottom portion of the port member 212. The base member 216 has a first end 232 that extends from the port member 212. A second end 234 of the base member 216 is connected to one end of the diaphragm 214 at an intermediate location 236 to be described in greater detail below. The base member 216 has an inner opening 238. The inner opening 238 will be in communication with the fluid container 211. The diaphragm 214 is a flexible member having one end 240 extending from an upper portion 242 of the port member 212. The diaphragm 214 has a second end 244 that is connected to the end 234 of the base member 216 at the intermediate location 236. As will be discussed in greater detail below, in one preferred embodiment when the valve 200 is attached to a flexible container 211, the diaphragm 214 will comprise a portion of one of the flexible sidewalls 222. The base member 216 and diaphragm 214 collectively comprise a housing 246 of the valve 200. A portion of the housing 246 is flexible from a first position to a second position to open the valve 200. In a preferred embodiment, the diaphragm 214 comprises the flexible portion of the housing 246. The port member 212 could also be included as part of the housing 246. The base member 216 and diaphragm 214 also collectively define a passageway 248 of the valve 200.

The stop member 218 is positioned generally between the diaphragm 214 and base member 216 within the passageway 248. The stop member 218 has an arm 250 and a plunger 252 having a plug 254 at a distal end of the plunger 252. The arm 250 is hingedly connected to the port member 212 by a flexible strap 256. The plunger 252 is connected to a distal end of the arm 250. The plunger 252 and the arm 250 are connected to a bottom surface 258 of the diaphragm 214. The plug 254 is positioned through the inner opening 238 and abuts a bottom surface 260 of the base member 216 to close the inner opening 238. The plunger 252 further has a pair of resilient members 262. The resilient members 262 bias the plug 254 against the bottom surface 260 of the base member 216 so that the plug 254 abuts against the bottom surface 260 to close the opening 238.

In one preferred embodiment, the valve 200 utilizes the diaphragm cover 220. The diaphragm cover 220 is positioned over the diaphragm 214. The diaphragm cover 220 has a collar 264 positioned around the port member 212 and connected proximately thereto. An opposite end of the diaphragm cover 220 is connected to the diaphragm 214 at the intermediate location 236. The diaphragm cover 220 has a vent 266. If desired, the valve 200 can also be equipped with the cap 221 that fits over the port member 212. A tamper evident sealing member 270 can also be included. The tamper evident sealing member 270 seals the cap 221 against the collar 264 and gives a visual indication of whether the valve 200 has been tampered with or previously manipulated.

As discussed, in one preferred embodiment, the valve 200 is attached to a fluid container 211 having flexible first sidewall 222 and flexible second sidewall 224. In this configuration and as shown in FIGS. 24 and 25, the valve 200 is inserted between peripheral edges of the sidewalls 222,224. The end 234 of the base member 216 is connected to an underside surface 272 of the first sidewall 222 at the intermediate location 236. The first sidewall 222 extends further wherein its peripheral edge is connected to the valve 200 proximate the port member 212. In this configuration, the portion of the first sidewall 222 extending from the intermediate location 236 to the connection proximate the port member 212 comprises the diaphragm 214. The bottom or second sidewall 224 is connected proximate the base member 216 at the port member 212 to seal the valve 200 to the container 211. The inner opening 238 is in communication with the inner chamber of the container 211 defined by the flexible sidewalls 222,224. It is understood that the valve 200 could have a diaphragm 214 constructed from a member separate from the sidewall 222.

Prior to operation of the valve 200, the cap 221 is secured to the valve 200 by the tamper evident strip 270. As shown in FIGS. 22 and 23, the tamper evident strip 270 is peeled away and the cap 221 is removed to expose the port 212.

FIGS. 24 and 25 generally disclose operation of the valve 200. In an initial state, and as shown in FIG. 24, the valve 200 is in a closed position wherein the plug 254 is biased against the bottom surface 260 to close the inner opening 238. In this first position, the passageway 248 has a first volume V1. The volume extends generally from the junction of the base member 216 and diaphragm 214 to the port member 212. A user places their mouth over the port member 212 and sucks to provide a partial vacuum through the passageway 248. The vacuum is a pressure less than an ambient pressure. As shown in FIG. 25, the vacuum acts on the lower surface 258 of the diaphragm 214 wherein the force associated with the index pressure forces the diaphragm 214 downwards. This moves the plunger 252 downwards in the direction of arrow A, wherein the plug 254 is spaced away from the inner opening 238 thus opening the valve 200. In this second position, the passageway 248 has a second volume V2. The second volume V2 is less than the first volume V1 as the diaphragm moved closer to the base member 216. It is also understood the area between the diaphragm 214 and the cover 220 increases to a volume of V3 in this position. In this position, the fluid is allowed to flow from the container 211, through the inner opening 238 in the direction of arrow B, through the passageway 248 and out the orifice 230 and outer opening 226 to be consumed by the user. Thus, when a vacuum is applied, a force is applied to the housing 246 in a first direction (arrow A) in response to the vacuum thereby placing the passageway 248 in the second position, wherein fluid flows through the passageway in a second direction generally shown as arrow C in FIG. 25.

Once the vacuum is removed, the valve 200 returns to the first position. The resilient members 262 bias the plug 254 against the bottom surface 260 of the base member 216 to close the inner opening 238 and therefore the valve 200. Fluid that passes through the orifice 230, after the vacuum has been removed, is consumed by the user. Fluid that remains in the passageway 248 when the vacuum is removed, however, does not drip from the valve 200. The change between the first volume V1 and the second volume V2 provides for an action that serves to withdraw the fluid from the outlet 238 back into the outlet passageway 229 such that the linear distance the fluid is withdrawn into the outlet passageway 229 is equal to the difference between the volume V2 and the volume V1 divided by the area of the outlet 238 which is sufficient to draw the fluid toward the passageway 248. The orifice 230 in the port member 212 is sized such that surface tension of the fluid across the orifice 230 maintains the fluid in the passageway 248 once the vacuum is removed. The molecules of the fluid will experience an inward force from the other fluid molecules wherein the fluid will act like an elastic sheet across the orifice 230. Molecules at the edges of the orifice will be attracted to the surface of the disk-shaped member 228 defining the orifice 230. Thus, due to surface tension of the fluid, the fluid already in the passageway 248 cannot pass through the orifice 230 until a vacuum is again applied. In an alternative embodiment shown in FIG. 25, the port member 12 can have a venturi structure 231 generally at the port member 212.

It can be understood that in this valve configuration as disclosed in FIGS. 21-25, the passageway 248 of the valve 200 defines a first chamber while the container 211 defines a second chamber. The plug 254 and inner opening 238 define a simple valve. In an initial state, the upper surface of the diaphragm 214 is subject to a first pressure, or index pressure PI. The passageway 248 could also be subject to the index pressure PI or some other first pressure. In one particular embodiment, the index pressure could be ambient pressure. The container 211 is subject to a container pressure PC. The container pressure could also be at ambient pressure. When a partial vacuum is applied by a user as shown in FIG. 25, the first chamber defined by the passageway 248 is subjected to a second pressure P2 that is less than the index pressure PI. In this state, the valve moves from a closed position to an open position wherein the fluid is allowed to flow through the outer opening 26. In one preferred embodiment, the index pressure PI represents ambient pressure, which in an equilibrium state is present in the passageway 248 and the container 211. In this initial state (FIG. 24), the index pressure PI is generally under ambient pressure and the plug 254 closes the opening 238. When the second pressure P2 is applied to the passageway 248 that is less than ambient pressure, a vacuum is present. This results in a force acting on the diaphragm 214 as explained above drawing the diaphragm downwards wherein the plug 254 moves away from the opening 238 allowing fluid to pass through the opening 238. Thus, a differential pressure is applied across the diaphragm 214 causing the valve 200 to open and allow fluid to pass through the opening 238. In one preferred embodiment, the pressure differential occurs from an index pressure that is ambient pressure. Thus, the valve 200 is actuated by applying a pressure less than ambient pressure. It is understood that a pressure differential could also be applied from an index pressure not equal to ambient pressure. It is also understood that the vacuum is typically applied by a user reducing the pressure through the passageway. The vacuum could also be applied by other means such as a syringe. A vacuum could also be applied by a pump or other mechanical means. Finally, it is understood that the designations of “first,” “second” and “third” with respect to the chambers, pressures and valve positions can be interchanged.

In an alternative method of valve actuation, a user can depress the diaphragm 214 through the cover 220 to move the plug 254 away from the inner opening 238. Fluid is then allowed to pass through the passageway 248 and out the outer opening 226.

The valve components can be made from a variety of materials. In preferred form of the invention, the valve components are made from an injection-molded process wherein the port member 12, base member 16 and portions of the stop member 18 are integrally molded. It is understood, however, that the valve components can be formed separately and connected to one another.

It is understood that the valve 10 can be incorporated into a tubing. A portion of the tubing can be flexible and provide the diaphragm 14. An opposite portion of the tubing can be provided with an opening to be in communication with the container 11. A stop member can be provided between the diaphragm 14 and opening.

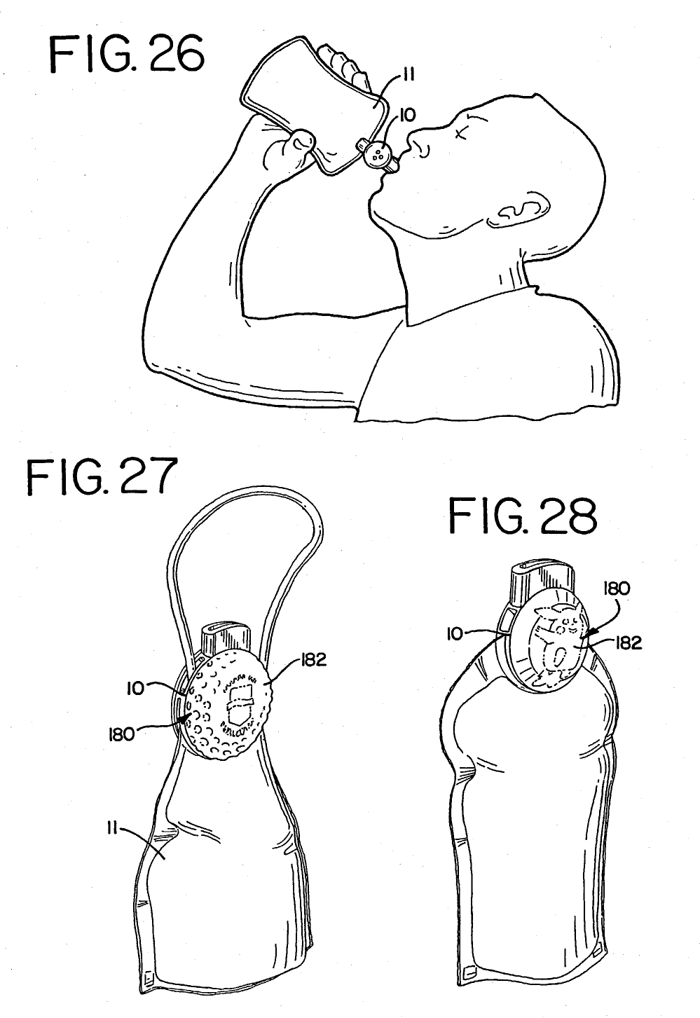

Thus, a device 10 (as well as the other disclosed devices) is provided that is simple in construction and use. As shown in FIG. 26, the valve 10 connected to a container 11 can be easily actuated by a user merely by applying a vacuum through the port member 12. Fluid is consumed as needed and will not drip from the valve 10. In addition, due to the construction of the device 10, fluid cannot be expelled through the valve 10 by squeezing the flexible sidewalls 22,24 of the container 11. To the contrary, squeezing the sidewalls 22,24 provides a greater seal as the plug 70 is forced further against the intermediate wall of the housing. Thus, if the container 11 is accidently compressed, fluid will not spray through the valve 10.

As shown in FIGS. 27 and 28, the valve 10 can be constructed wherein, for example, the diaphragm cover 20 can have a distinctive shape 180 (FIGS. 27 and 28) or an indicia-bearing surface 182 (FIG. 28) for promotional purposes or to provide for branding opportunities.

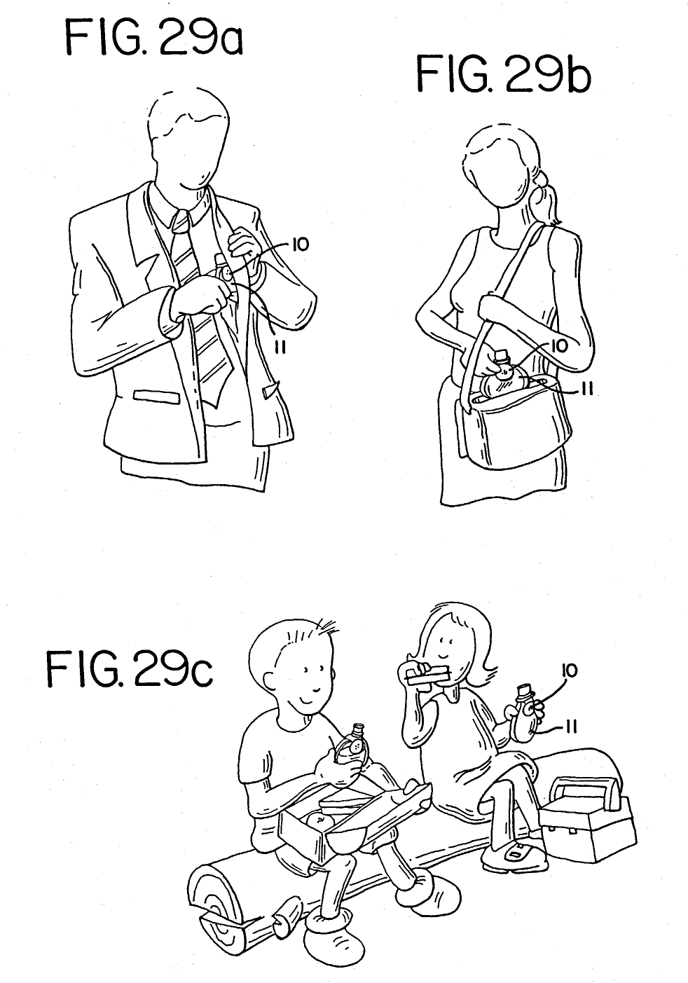

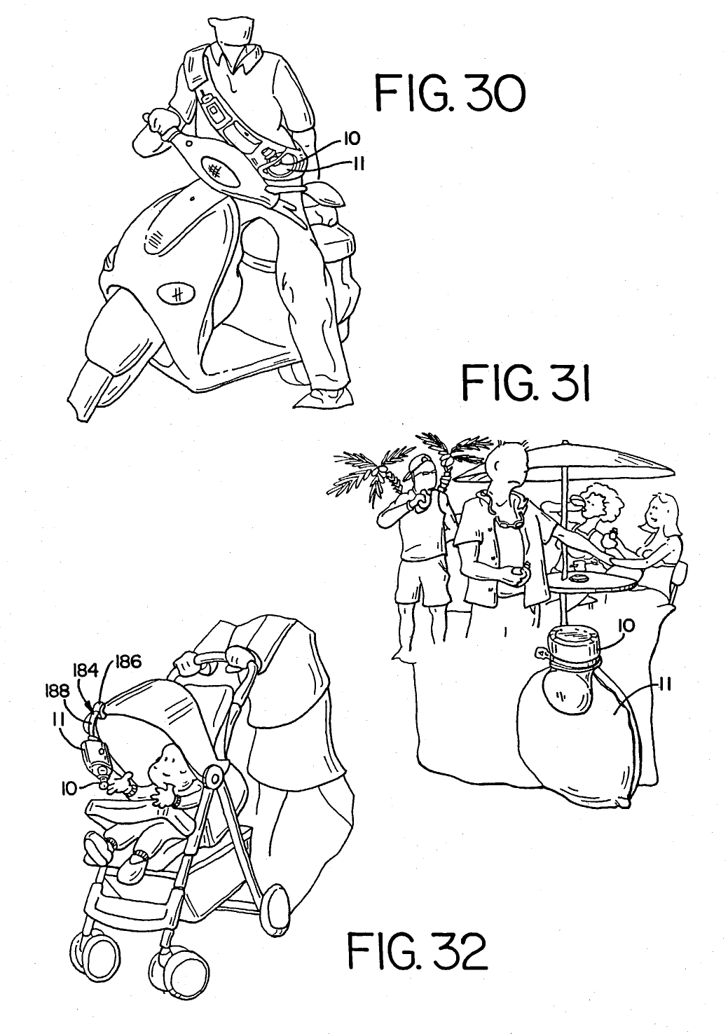

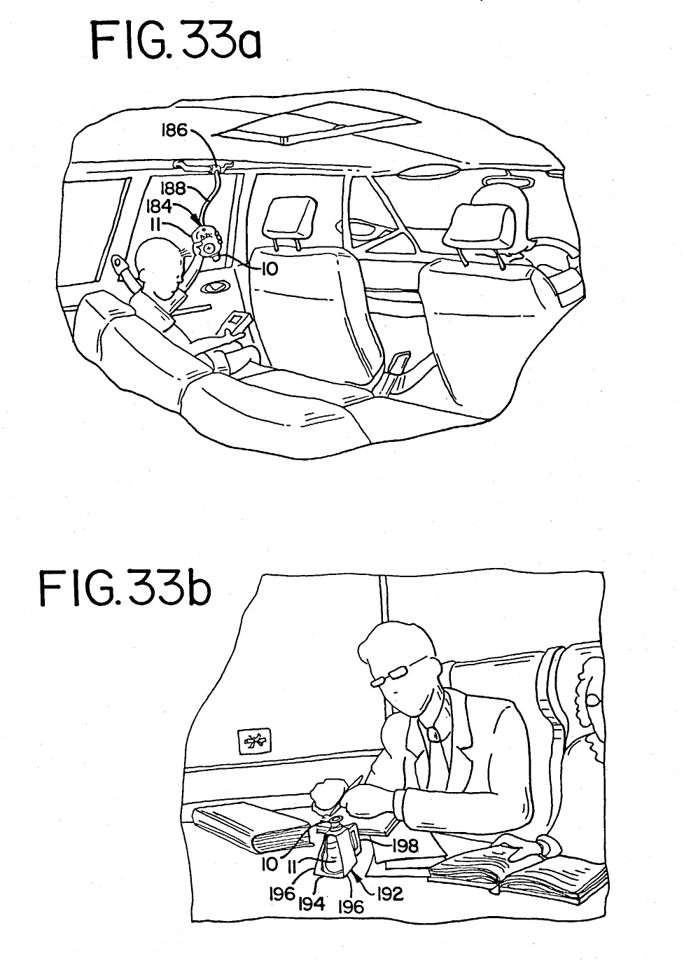

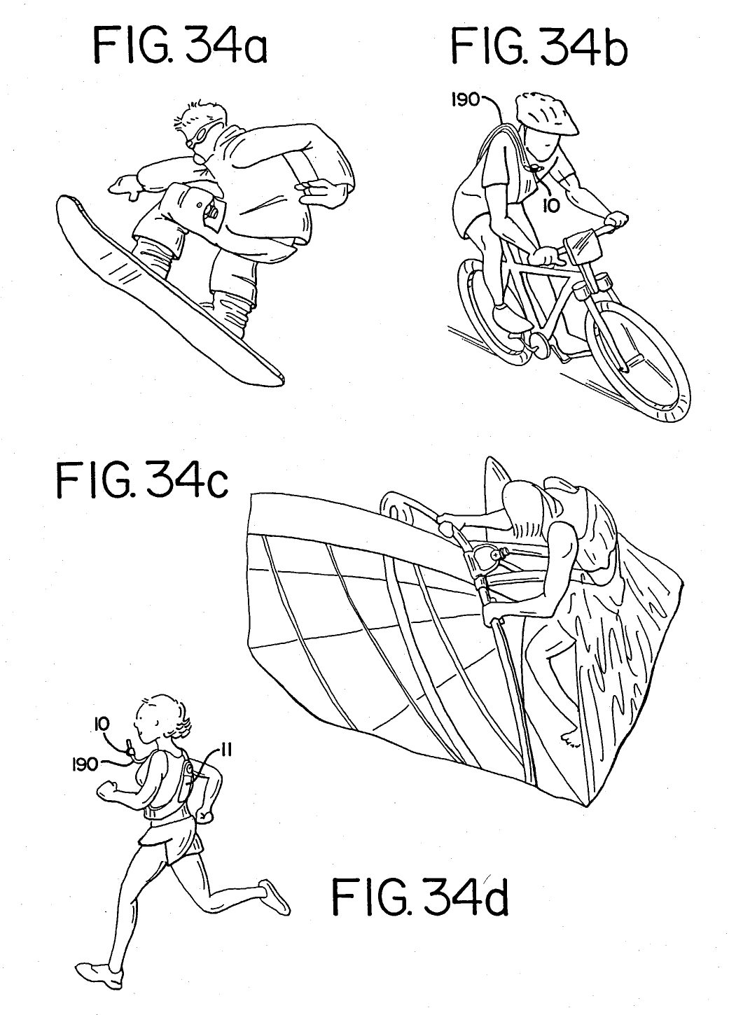

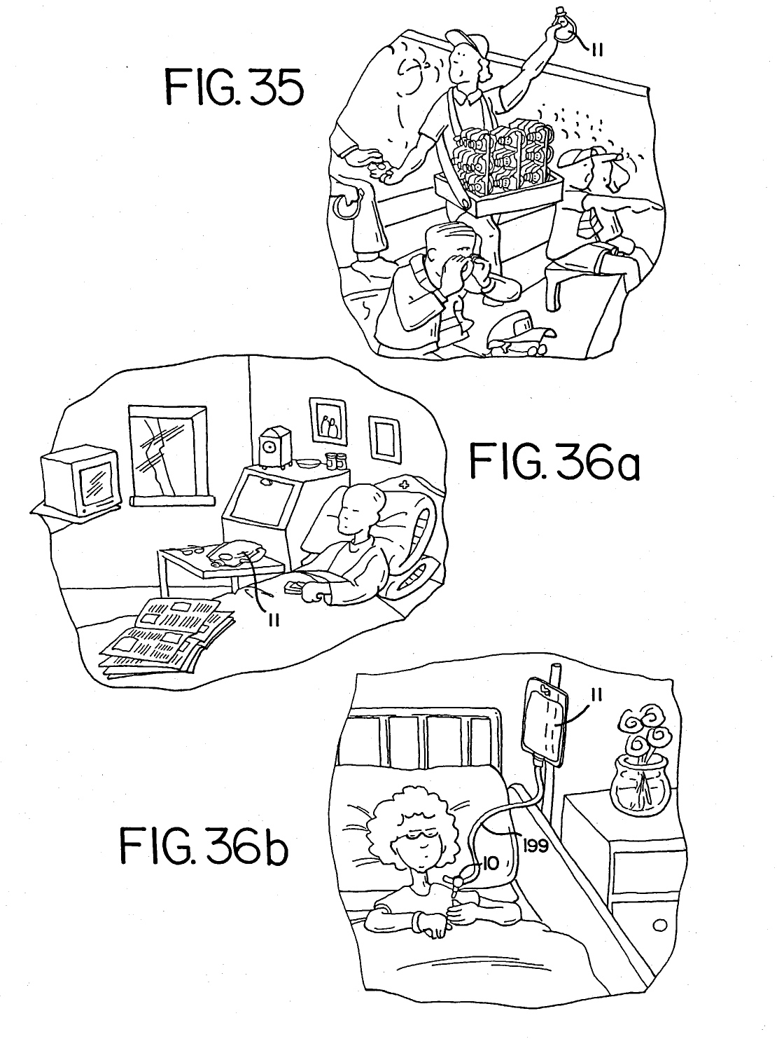

Containers utilizing the flowable material delivery device/valve of the present invention have a broad variety of uses and applications. The valve 10 is ideal for using with hot or cold drinks, as well as non-carbonated drinks. Users can easily carry such a container 11 on their person (FIGS. 29 and 30). Containers 11 holding, for example, juice or milk, can also be used for children and infants (FIGS. 29 and 32). The containers 11 can also have a hanger member 184 associated therewith. As shown in FIGS. 32 and 33a, the hanger member 184 may include a clamp 186 and a band 188 connecting the clamp 186 to the container 11. The clamp 186 can be removably affixed to a support member. The support member can include a plurality of different types of members such as in a vehicle (FIG. 33a) or a stroller (FIG. 32) such as for an infant. The container 11 can then be hung from the support member to be grasped by a user. As shown in FIG. 34c, the clamp 186 can also be directly attached to the container 11. The containers 11 can also be utilized in a number of different recreational settings (FIGS. 31 and 35). The containers 11 are also ideal when taking part in active sporting activities (FIGS. 34a-d). As shown in FIG. 34b and 34d, the container 11 could have a flexible tubing 190 attached thereto and a valve 10 attached to a distal end of the tube 190 wherein the tube 190 can be easily accessed hands-free such as when cycling or running. The container 11 can also be grasped with a single hand and the fluids consumed without further manual manipulation of the valve 10 (See FIG. 26). The containers 11 are further ideal to use when traveling (FIGS. 33a-b).

The container 11 can further be designed to stand upright in a predetermined position. As shown in FIG. 33b, the container 11 can also have a carrier 192 that can support the container 11 in a predetermined position. In one embodiment, the carrier 192 can have a base 194 and sidewalls 196. The carrier 192 may also have a handle 198. Finally, as shown in FIGS. 36a and 36b, the container 11 can be used by patients in a hospital setting. As further shown in FIG. 36b, an elongated tubing 199 can be attached to the container 11 with the valve 10 on the distal end of the tube. Uses also comprehended by the scope of the invention include storage and dispensing of industrial chemicals, medicaments or any other flowable material.

The valve 10 provides several benefits. The container 11 and valve 10 are low-cost and designed for single-use consumption wherein the container 11 and valve 10 can be discarded when the container 11 is empty. The valve 10, however, could also be used in multi-use applications. The valve 10 is suction-activated wherein the user can drink through the valve 10 as easily as with a conventional straw. The housing structure and valve function also prevent dripping from the valve. The structure of the valve 10 prevents fluid from being drawn back into the container once through the internal opening. The structure of the valve 10 also resists pressure from the container 11 and cannot be accidently activated. The valve 10 is not required to be recapped once opened as the valve 10 returns to its closed position upon non-use. The valve components are easily manufactured such as by an injection-molded process in one preferred embodiment. Because the valve can be constructed from certain injection-moldable materials, the valve can be operable through a broad range of temperatures and for extended periods of time.

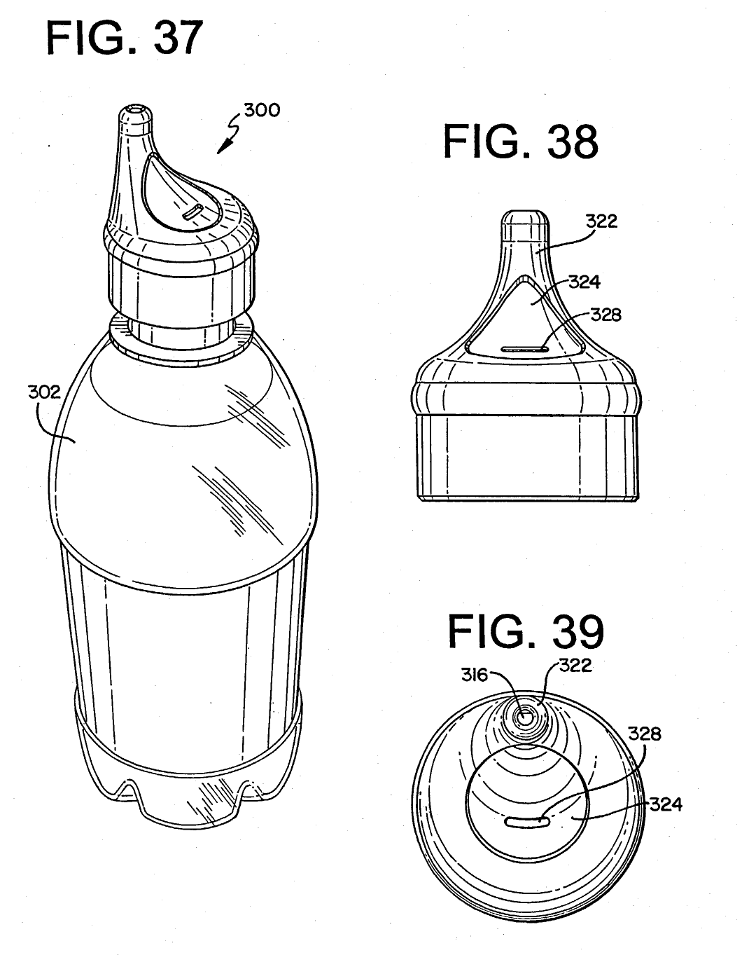

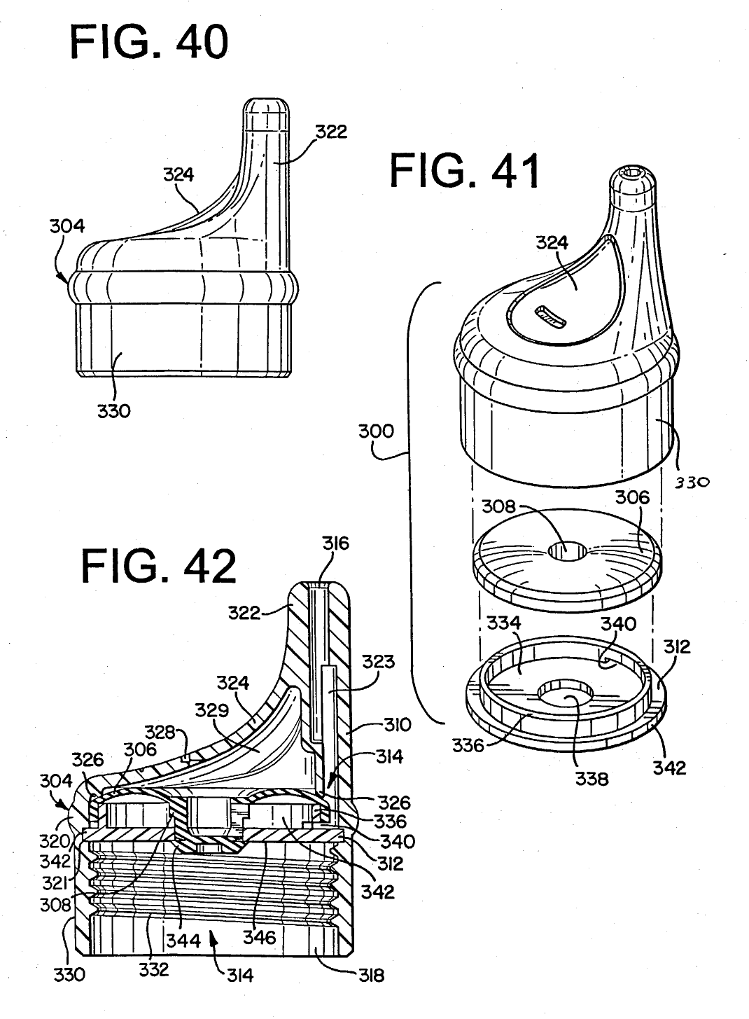

FIGS. 37-44 disclose another embodiment of the vacuum demand flow valve of the present invention, generally referred to with the reference numeral 300. The vacuum demand flow valve 300 is shown attached to fluid container 302 in FIG. 37. It is understood that the valve 300 can be used with various types of containers that contain a flowable material or substance. FIG. 37 shows one preferred embodiment of a fluid container 302 in the form of a container typically designed to hold a carbonated beverage such as soda pop. The container 302 could also hold other non-carbonated fluids as well.

As generally shown in FIGS. 41 and 42, the vacuum demand flow valve 300 generally includes a housing 304 and a flexible diaphragm member 306 having a stop 308. The housing 304 generally includes a port member 310 and a base 312.

As shown in FIGS. 38-42, the port member 310 of the housing 304 is generally tubular and defines a passageway 314 between an outlet opening 316 and an inlet opening 318. The port member 310 has a central portion 320 at a generally intermediate location of the port member 310. The central portion 320 has an inner groove 321. A spout 322 and a sloped wall 324 extend from one side of the central portion 320. The spout 322 defines a first portion 323 of the passageway 314. The passageway 314 may have an offset structure to achieve as small a profile as possible. This structure may be referred to as a core shut off. The port member 310 has an inner rim 326 on an inner surface of the sloped wall 324. The sloped wall 324 also has a vent opening 328. A vent chamber 329 is defined within the port member 310 and cooperatively formed with the diaphragm 306 as is shown in FIG. 42. An annular wall or skirt 330 extends from an opposed side of the central portion 320. The annular wall 330 has threads 332 on an inner surface. The annular wall 330 serves as an attaching member wherein the threads 332 are adapted for sealing engagement with a threaded opening of the fluid container 302. The spout 322 of the port member 310 is generally sized such that a user's mouth can fit comfortably over the port member 310. The port member 310 may be provided with a cap (not shown) that can be secured to the port member 310 prior to use. A tamper evident strip (also not shown) could be provided to seal the cap to the spout 322.

As shown in FIGS. 41 and 42, the base 312 has an internal wall 334 having an annular rim 336 extending therefrom. The internal wall 334 has an inner opening 338. The annular rim 336 has an aperture 340. A second portion 342 of the passageway 314 is defined between the inner opening 338 and the aperture 340. In one preferred embodiment, the second portion 342 of the passageway 314 is generally transverse to the first portion 323 of the passageway 314. The base 312 has a peripheral edge 342 that is received in the inner groove 321 in the central portion 320 of the port member 310. As shown, in a preferred embodiment, the base 312 is generally annular.

As further shown in FIGS. 41 and 42, the diaphragm 306 is generally a flexible member. The stop 308 is integrally formed with the diaphragm 306 and extends from a generally central portion of the diaphragm 306. The stop 308 passes through the inner opening 338 and has a flange 344 that is adapted to be in sealing contact with an underside surface 346 of the internal wall 334 to seal the inner opening 338. As shown in FIGS. 42, the diaphragm 306 is connected over the annular rim 336 and is sized such that the diaphragm 306 is in slight tension over the annular rim 336 to provide a sealed connection over the annular rim 336. The inner rim 326 of the port member 310 engages a top surface of the diaphragm 306. The diaphragm 306 is formed such that when connected to the annular rim 336, the stop 308 is biased against the internal wall 334 to seal the inner opening 338. Alternatively, a spring or other biasing member may be positioned between the internal wall 334 and the diaphragm 306. As discussed the vented chamber 329 is defined between the diaphragm 306 and the sloped wall 324 of the port member 310. As discussed in greater detail below, the diameters of the diaphragm 306 and stop 308 can be set within certain ranges wherein the valve 300 can be easily operated with a carbonated beverage container.

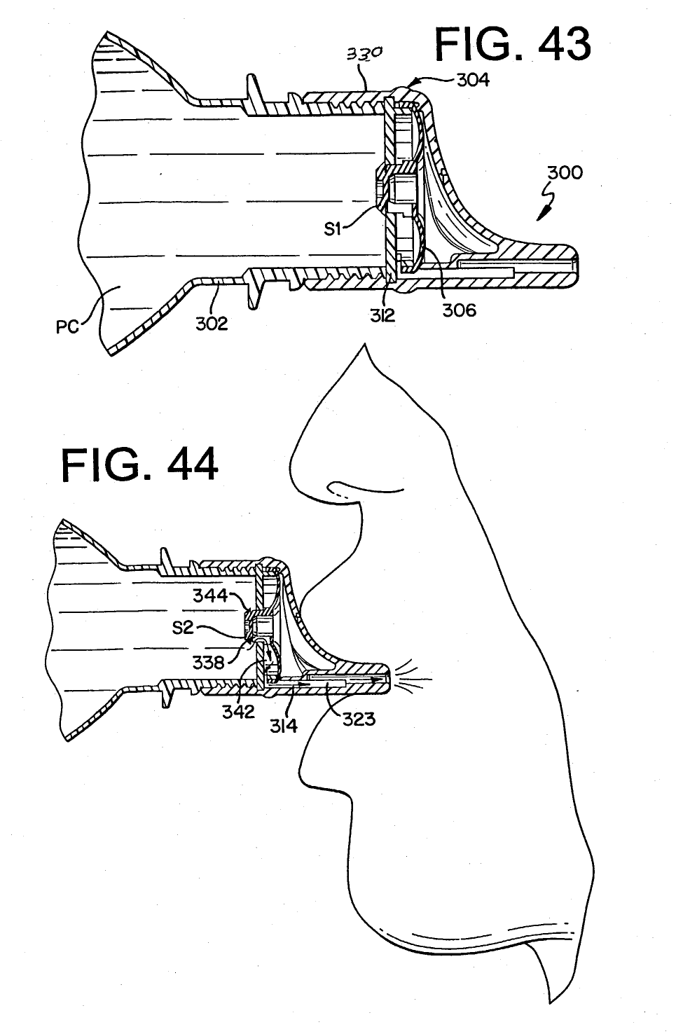

FIG. 43 shows the valve 300 and fluid container 302 wherein the valve 300 is closed. As shown, fluid 327 within the container 302 does not leak when the fluid 327 is in contact with the closed valve 300. The valve 300 is secured to the fluid container 302 by threads 332 which allow the valve to be screwed unto the container 302. In other embodiments, the valve may have flexible semi-rigid members (not shown) which allow it to be snapped on. The valve may be glued on, or many other methods of attachment which immediately come to mind and are well known in the art may be used.

FIGS. 43 and 44 show the valve 300 connected to the container 302. The valve 300 operates similarly to the valves previously described and is subjected to similar pressures as previously described. However, when the container 302 holds a carbonated fluid, the pressure PC in the container 302 is a positive pressure. As shown in FIGS. 43 and 44, the diaphragm 306 is deflectable from a first position S1 to a second position S2. When the diaphragm 306 is in the first position S1, the stop 308 is in sealing contact with the underside surface 346 of the internal wall 334 to close the inner opening 338. When the diaphragm 306 is in the second position S2, the stop 308 is spaced from the inner opening 338 to open the inner opening 338 wherein the carbonated liquid is allowed to pass through the inner opening 338 and through the second portion 342 and first portion 323 of the passageway 314. As discussed, the diaphragm 306 is preferably deflectable by a vacuum applied by a user as shown in FIG. 44. Because the container 302 holds a carbonated fluid under a positive pressure, the user must supply a sufficient vacuum to overcome the force applied to the stop 308 from the pressure in the container 302. By inhaling on the port member 310, a typical user will provide in the range of from about −0.5 psi to about −1.25 psi of suction when inhaling on the port member 310. In a preferred embodiment the amount of suction required to operate the valve 10 so that it is opened, is near to, or below, the lower end of this range. Most preferably, a user must supply about −0.3 psi of suction to open the valve 300. The stop 308 has a reduced diameter which lowers the force applied to the stop 308 against the internal wall 334 by the pressure of the carbonated liquid contained in the container. This allows the valve 300 to be actuated at the desired range of suction pressures notwithstanding the pressure against the stop 308 from the carbonated liquid.

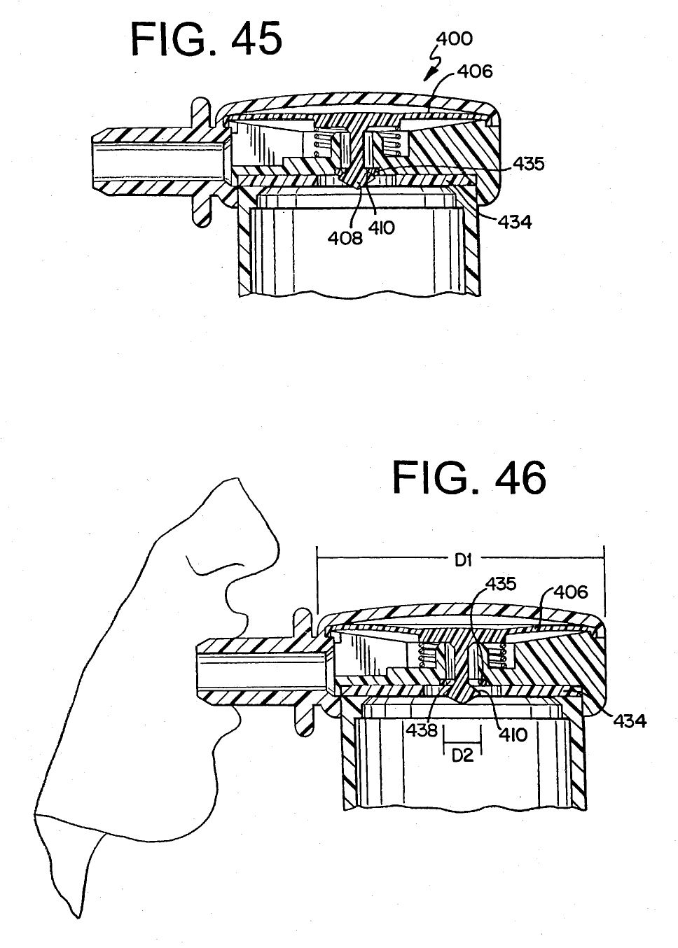

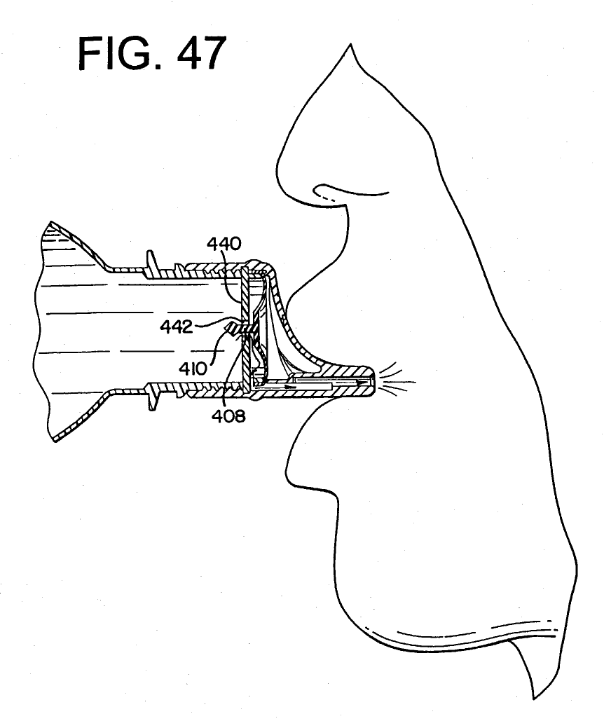

FIGS. 45 and 46 disclose another embodiment of the vacuum demand flow valve of the present invention, generally referred to with the reference numeral 400. The valve 400 has similar structure to the valves described above, but has a diaphragm 406 having a modified stop 408. The valve 400 has an internal wall 434 having an inner surface 435 defining an inner opening 438 The stop 408 has a frustoconical surface 410. As shown in FIG. 45, when the diaphragm 406 is in the first position, the frustoconical surface 410 is in sealing contact with the inner surface 435 of the inner opening 438. When in the open position as shown in FIG. 46, the stop 408 is spaced from the internal wall 434 to open the inner opening 438. FIG. 47 shows the stop 408 installed in a valve similar to valve 300. An internal wall 440 has an inner surface 442 that is frustoconical. The frustoconical inner surface 442 is shaped to correspond to the frustoconical surface 410 of the stop 408. The mating frustoconical surfaces provide an enhanced sealing area.

The stop 408 is particularly suitable for valves used with containers holding carbonated beverages. The diaphragm has a diameter D1 and the stop 418 has a diameter D2. The stop diameter D2 is reduced to allow for easier opening of the valve. Thus, one way in which the suction required to operate the valve can be manipulated is by changing the ratio of the area of the diaphragm to the area of the stop. Carbonated beverages or flowable materials having high vapor pressures will tend to cause a higher pressure in a container. This higher pressure will exert a greater force on the stop than an uncarbonated fluid assuming the same sized stop is used. This force adds to the seal formed by the stop. To compensate for this additional force, the ratio of the diaphragm diameter D1 to the stop diameter D2 is generally greater for use with containers containing carbonated fluids. To change the ratio, either the diaphragm size can be increased, or the stop size decreased. In the preferred embodiment for use with carbonated fluids, the stop size is decreased as shown in FIGS. 45-47 as compared to the stop shown, for example in FIG. 5. The stop size of the valve shown in FIGS. 42-44 can also be further reduced.

As discussed, the valve of FIGS. 37-52 are preferably suitable for use with carbonated beverage containers. The valves are suitable for carbonated beverages having pressures up to 30-40 psi. Ratios for the diaphragm diameter D1 to the stop diameter D2 are generally in the range of from 80:1 to 5:1. For noncarbonated fluids which have a vapor pressure generally at or near ambient, a ratio in the range of from about 5:1 to about 15:1, or sub-ranges therein are preferred. A ratio of approximately 10:1 has been found most preferable. For carbonated fluids, a ratio in the range of from about 60:1 to about 80:1, or sub-ranges therein are preferred. A ratio of approximately 70:1 has been found most preferable. The ratio which is most preferable for a specific fluid and use will be that which ultimately places the suction required to activate the valve within the desired range, which may vary based upon the application for which the valve 10 is used. As stated above, generally the desired suction required to activate the valve is in the range of from about −0.3 psi to about −0.125 psi. In one preferred embodiment for a valve for a carbonated beverage container such as the valve 300 in FIG. 37, the diaphragm is in the proximate range of 20 mm while the valve stop is in the range of about 3.5 mm. The opening in the internal wall is approximately 3 mm. Accordingly, it can be understood that with a carbonated beverage, the valve stop diameter is reduced from the valve stop diameter such as for the stop shown in FIG. 5. This reduces the force that the valve stop is subjected to from the pressure of the carbonated beverage. Thus, the valve can still be opened by applying the desired suction within the range discussed above, notwithstanding that the container holds a carbonated beverage under pressure. For example, explained in more general terms, the valve can have an inlet at a first pressure and a valving member, such as the valve stop, reactive to said first pressure. The valving member is operatively connected to a second member, such as the diaphragm, which is sensitive to a second pressure such that said valving member selectively allows a fluid connection between said inlet and an outlet when a differential in pressure is applied to said second member so as to apply a force to said valving member greater than the force applied to said valving member by said first pressure and an orifice, such as the internal opening of the internal wall, associated with said valving member sized as to allow said first pressure to be substantially reduced toward said second pressure upon approaching said outlet.

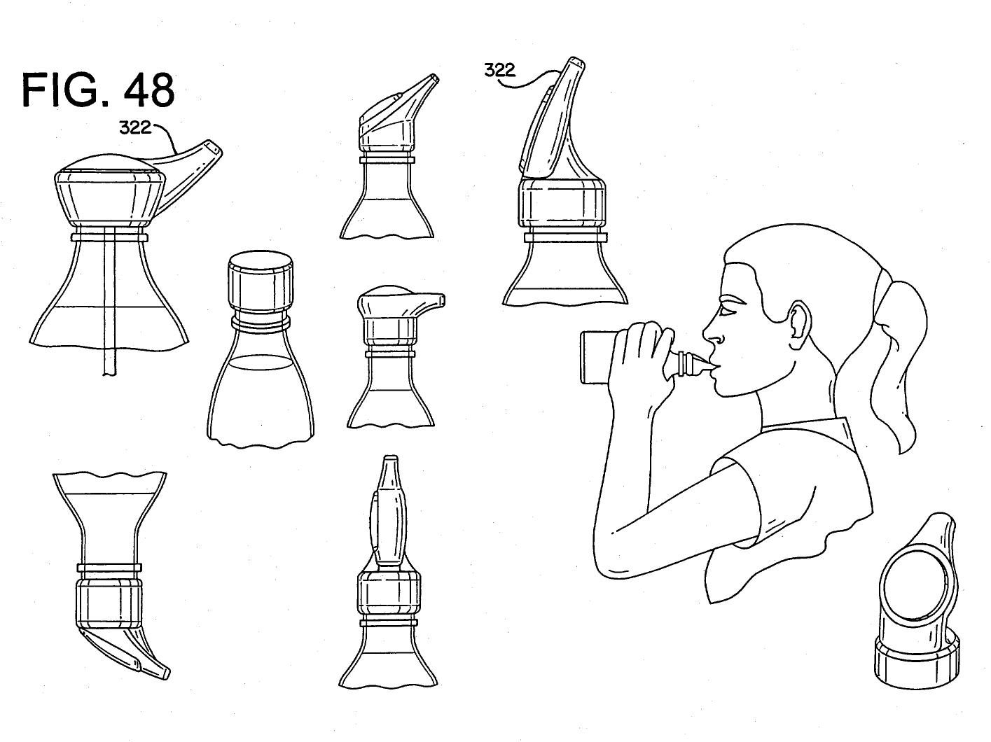

FIG. 48 shows additional embodiments of the valve 300. In general, it is shown that the spout 322 of the port member 310 can be configured to various angled positions. The spout 322 is angled from a longitudinal axis L of the container. This can improve the flow and consumption characteristics of the valve and further improve the ergonomics associated with the valve design. Thus, as shown, a user can easily consume a beverage from the container without undue tilting of the head. The spout 322 can also be configured to a straight position.

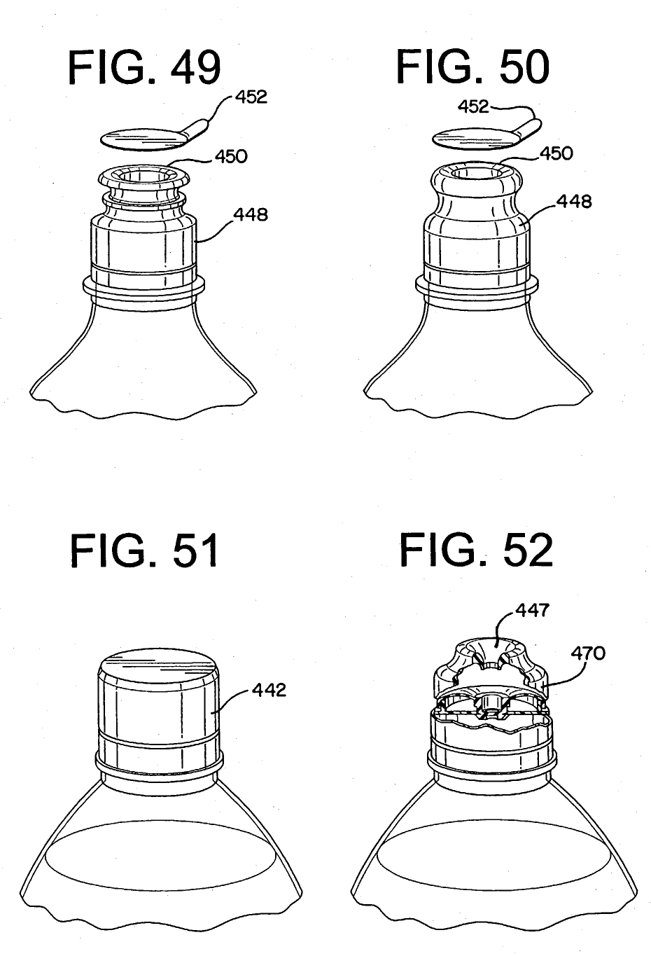

FIGS. 49 and 50 also show additional embodiments of the valve that has similar internal structure as the valve 300. A port member 448 of the valve can have an opening 450 that is designed to be closed by a tear-away tamper evident seal member 452. The opening 450 can be wide (FIG. 49) or narrow (FIG. 50). The port member 448 can be designed to screw onto a threaded opening of a container.

Similarly, FIGS. 51 and 52 schematically show a valve 470 having similar structure as the valve 300. As shown in FIG. 51, the valve 470 can have a cap 472 such as used with a traditional disposable pop or water bottle. FIG. 52 shows the valve 470 with the cap 472 removed. It is understood that the internal structure of the valve 470 can be configured such that when one applies a suction to an opening 474, a force is applied to the appropriate side of the diaphragm in order to actuate the valve and provide a fluid passage through the valve.

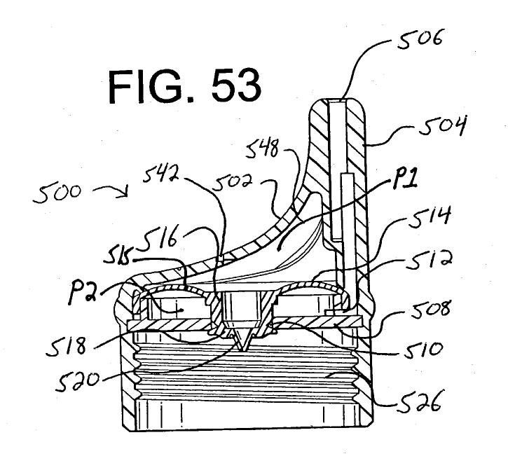

Another embodiment of the valve of the present invention is shown in FIGS. 53-57. The valve is generally represented by reference numeral 500. The valve 500 generally has a housing 502 and a member 514. Generally, the member 514 is a deflectable member.

The housing 502 generally includes a port member 504 which defines an outer opening 506. The housing 502 may further include a base member 508 having an inner opening 510. The housing 502 generally defines at least a portion of a passageway 512 between the outer opening 506 and the inner opening 510. A chamber 548 is generally defined by the housing 502 and the deflectable member 514. The chamber 548 generally includes a vent 542 to the ambient environment which is remote from the outer opening 506. The housing generally includes threads 526, or other means for attaching the valve 500 to a fluid container.

As discussed, the valve 500 generally includes the deflectable member 514. The deflectable member preferably includes a diaphragm 515. The deflectable member 514 of this embodiment preferably forms a passageway 512 between itself and the housing 502 in communication with the outer opening 506. The member 514 may have a connected or integrally formed stop 516. The stop 516 preferably includes a plug 518, or sealing member, which fits within the inner opening 510.

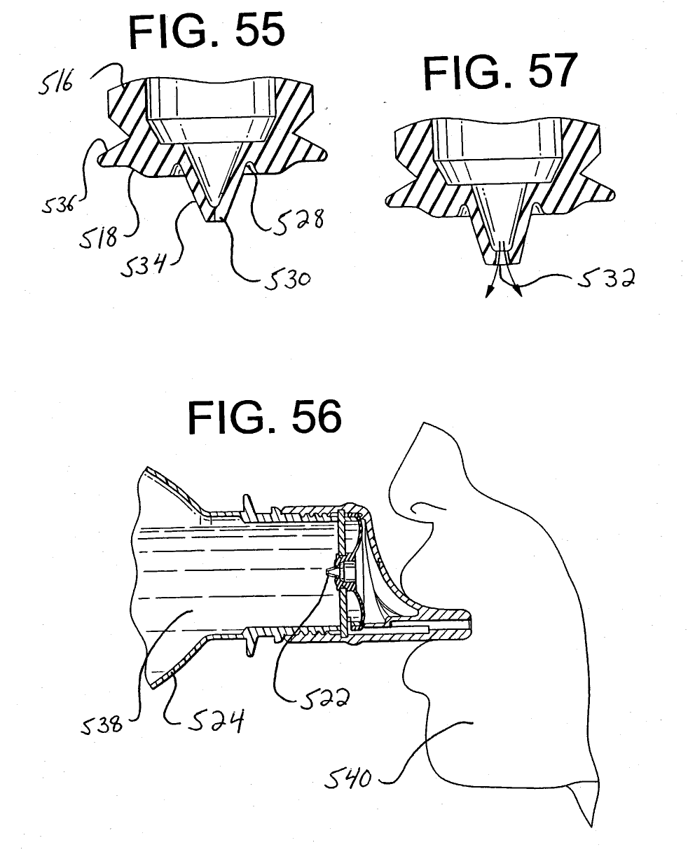

The stop 516 may have a sealing member 518 formed from a molding process using a material which allows the sealing member 518 to be folded over from a first molded position (not shown) into a second position wherein it is used to seal an opening as shown in FIGS. 55 and 57. This type of stop is discussed in U.S. patent application Ser. No. 10/095,894, entitled “Valve Stop,” the contents of which are hereby incorporated by reference. The sealing member 518 in the molded position (not shown) is generally cone shaped with its base opening downwards. The sealing member 518 is then folded so that a sealing surface 536 can be used to form a fluid tight seal to plug the inner opening 510. It is understood that a valve stop of this type could be utilized in many of the embodiments described herein. In addition, such a valve stop could include a vent as described in detail below.

In this embodiment, a vent 520 is associated with the stop 516. The vent 520 generally includes a vent member 522. The vent member 522 is preferably incorporated to the stop 516, and generally integrally molded with the stop 516 during manufacture. The vent member 522 includes a base end 528 and a distal end 530 as shown in FIG. 55. The distal end 530 generally includes a sealable opening 532. The sealable opening 532 is generally an opening made proximate to, or at the distal end 530. The opening is preferably a slit. The vent member 522 may be in the shape of a cone, truncated cone, i.e., frustoconical in shape, a wedge, or other shapes, and is generally hollow. In the embodiment shown in FIGS. 53-57, the vent member 522 includes an outer surface 534 which tapers from the base end 528 to the distal end 530. The distal end 530 generally extends into a fluid container 524.

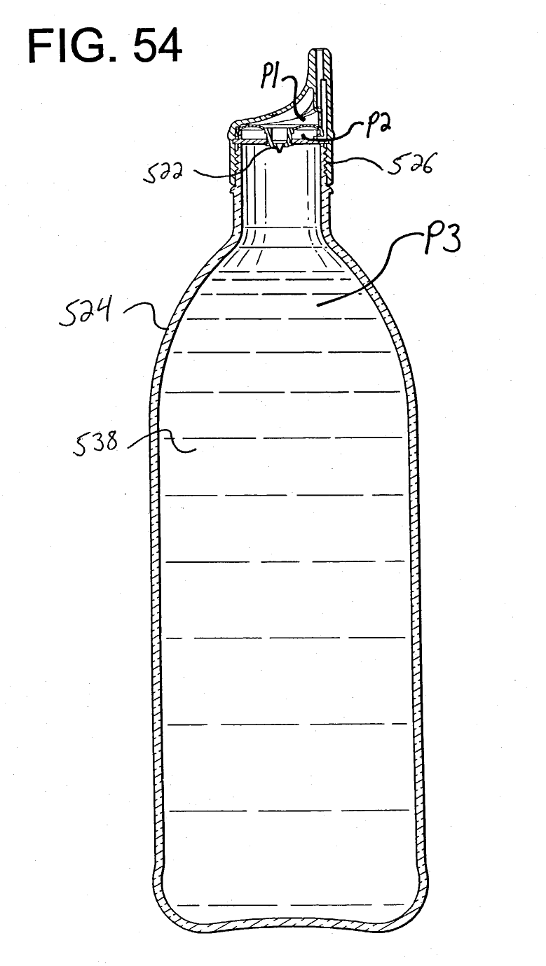

FIG. 54 shows the valve of the present embodiment attached to a fluid container 524 in a vertical position having a fluid 538 therein. The threads 526 of the housing 502 are used to attach the valve 500 to the fluid container 524 as shown in FIG. 54. In use, the fluid container 524 is generally rotated to a horizontal position which brings the fluid 538 into contact with the valve 500 as shown in FIG. 56. A user 540 then generally applies a suction force to the port member 504. When a suction force is applied, the valve 500 opens, and liquid flows out of the fluid container 524 to the user 540.

In the present embodiment, activation of the valve 500 is based on pressure differentials which apply forces which cause the valve 500 to go from a closed to an open position. In the closed position, chamber 548 is generally at a first pressure P1, or index pressure. The designation of first, second, third and the like to pressures or structure is interchangeable in describing different embodiments, and the designations in this embodiment do not necessarily apply in others. The passageway 512 between the outer opening 506 and the inner opening 510 is at a second pressure P2, which is equal to P1 when no suction is applied to port 504. P1 and P2 are both at ambient pressure when no suction is applied to the outer opening 506 because passageway 512 is in communication with the outer opening 506, and chamber 548 is vented to the environment by vent 542. The fluid container 524 is generally at a third pressure P3. The vent 520 is generally exposed to the first pressure P1, and the third pressure P3. The pressure within the fluid container 524 tends to push the vent 520 together so that the sealable opening 532 remains closed as shown in FIG. 55. P3 may vary depending on the fluid stored in the container. When a carbonated beverage is stored in a fluid container, the pressure created by the fluid is generally greater than when an uncarbonated beverage is stored in a container.

The first pressure P1 is generally ambient pressure provided by the environment surrounding the valve 500. The vent 542 is generally provided in the housing 502 to supply ambient pressure to the deflectable member 514. The first pressure generally acts on the deflectable member 514 by pushing down on its top surface, and tends to push the deflectable member 514 downward, which would cause the plug 518 to move from the inner opening 510, opening the valve. However, the deflectable member 514 is subject to biasing forces which work counter to the first pressure P1, or index pressure, to keep the valve 500 closed. The biasing forces are generally supplied by the second pressure P2 in passageway 512, which is generally the same as the first pressure P1 when no suction force is being applied to outer opening 506. In addition, the deflectable member 514 is also biased against the first pressure by other forces, preferably provided by a resilient force associated with the structure of the deflectable member 514. The resilient force associated with the structure of the deflectable member 514, the second pressure P2, and the third pressure P3 acting upon the plug 518 from within a fluid container 524 all bias the deflectable member 514 to a first position wherein the valve 500 is closed.

When a user 540 applies a suction force to outer opening 506, the second pressure P2 within the passageway 512 is reduced. The reduction of the second pressure P2 allows the force supplied by the first pressure P1 acting on the deflectable member 514 to overcome the remaining biasing forces which generally keep the valve 500 closed. The deflectable member 514 then moves to a second position wherein the plug 518 moves from the inner opening 510. The valve 500 is then open, allowing fluid 538 to flow from the fluid container 524 through the inner opening 510, into the passageway 512, and out of the valve 500 through the outer opening 506.

When fluid 538 is removed from the fluid container 524 by, for example, a user 540 sucking some of the fluid through the valve 500, the third pressure P3 is reduced by the vacating of fluid. The vent 520 functions to equilibrate the first pressure P1, or index pressure, and the third pressure P3, or pressure in the container, by filling the space left by the vacated fluid. The vent 520 therefore opens when the ambient pressure is greater than the pressure within the fluid container 524 as shown in FIG. 57. A minimum activation pressure difference is generally required to overcome biasing forces within the vent 520 structure. Therefore, the pressure outside the container 524 may be slightly greater than the pressure within the container 524, yet the vent will remain closed until the minimum activation pressure difference is attained. When the pressure within the fluid container 524 is restored to a pressure where it is substantially equal to the ambient pressure, the vent 520 closes.

The vent 520 is a one way vent which only opens when the ambient pressure is greater than the fluid container 524 pressure, but not vice versa. Therefore, when a carbonated beverage is stored in the fluid container the pressure within the fluid container 524 may be greater than ambient pressure, but the vent 520 of this embodiment will remain closed. When the pressure within the fluid container 524 is greater than the ambient pressure the pressure above the fluid 538 exerts a closing force on the vent member 522 which tends to push the sealable opening 532 to the closed position.

The addition of the vent 520 to the valve 500 has numerous functional benefits. The valve 500 of this embodiment used for dispensing fluid from a rigid container results in a constant flow rate of fluid from the container. The vent 520 prevents a “suck back” effect from occurring. If a vent is not present, the vacated volume of removed fluid may be filled by the evaporation of some of the remaining fluid, and the expansion of other gas remaining in the container. The pressure within the container will therefore be reduced overall, and relative to ambient pressure. As more and more fluid is removed, the internal pressure of the container will continue to decrease, and the removal of additional fluid will get progressively harder. While the valve will not be harder to open, when it is open, the suck back effect from the low pressure within the container will have to be overcome by the suction applied to the outer opening by a user. The flow rate would therefore decrease as progressively more fluid was removed from the rigid container if the vent 520 were not present. The undesirable suck back effect when withdrawing a fluid from a rigid container is reduced or eliminated through the use of the vent 520 incorporated into the valve 500. With a vented valve, the user 536 may use the valve 500 to remove fluid 538 from a container at a constant flow rate using a constant suction force applied to the outer opening 506, regardless of how much fluid has already been removed from the container.

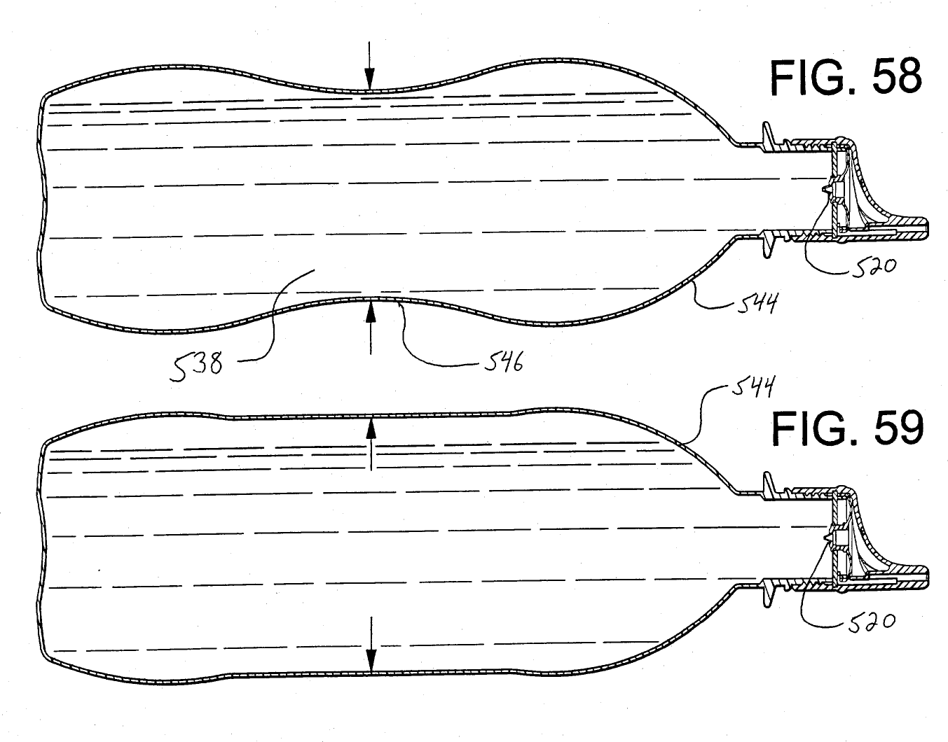

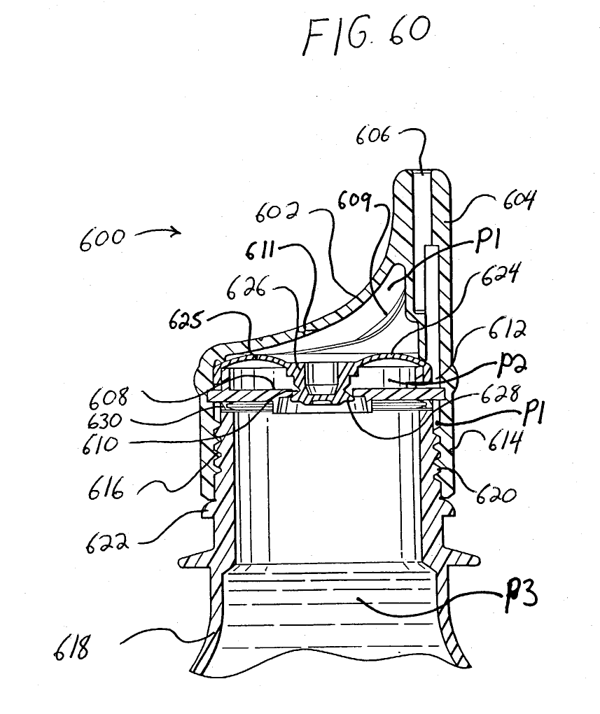

It is often desirable to use the valve 500 of the present invention in conjunction with a semi-rigid container. A flexible plastic bottle 544 as shown in FIGS. 58-59 is one example of a semi-rigid container. When a user removes fluid 538 from the valve by sucking on the valve 500, or otherwise applying a suction force, they may simultaneously squeeze the flexible plastic bottle 544. This may cause the sides 546 of the plastic bottle 544 to indent. When a user has finished removing fluid 538 from the plastic bottle 544 it will have indented sides 546 as shown in FIG. 58. The elasticity of the plastic bottle 544 will generally allow the indented sides 546 to return to their original un-indented form, provided the pressure within the plastic bottle 544 is maintained as substantially equal to the pressure outside the flexible plastic bottle 544. The vent 520 of this embodiment allows the pressure within the bottle 544 to be maintained as substantially equal to, or greater than, the pressure outside the bottle 544, even while the volume of the bottle is increasing from its indented volume to its original volume. Therefore, when a user 540 stops squeezing, air will begin entering through the vent 520, and the plastic bottle 544 will return to its original shape.

The same principle applies even if a user 540 did not squeeze the flexible plastic bottle 544, but simply removed fluid 538 from the bottle 544 without having a vent 520 to replace the vacated volume of the removed fluid. The sides 546 of the flexible plastic bottle 544 would again tend to indent due to the pressure differential between the interior and exterior of the bottle. However, the vent 520 prevents this undesirable indenting from occurring by replacing the removed fluid 538 with air from the environment. The vent 520 of this embodiment is capable of replacing the removed fluid with air simultaneous to the removal of the fluid. The vent 520 is exposed to ambient pressure by a vent 542 in the housing 502. This maintains the chamber 548 above the vent 520 at ambient pressure regardless of whether the valve 500 is opened or closed.

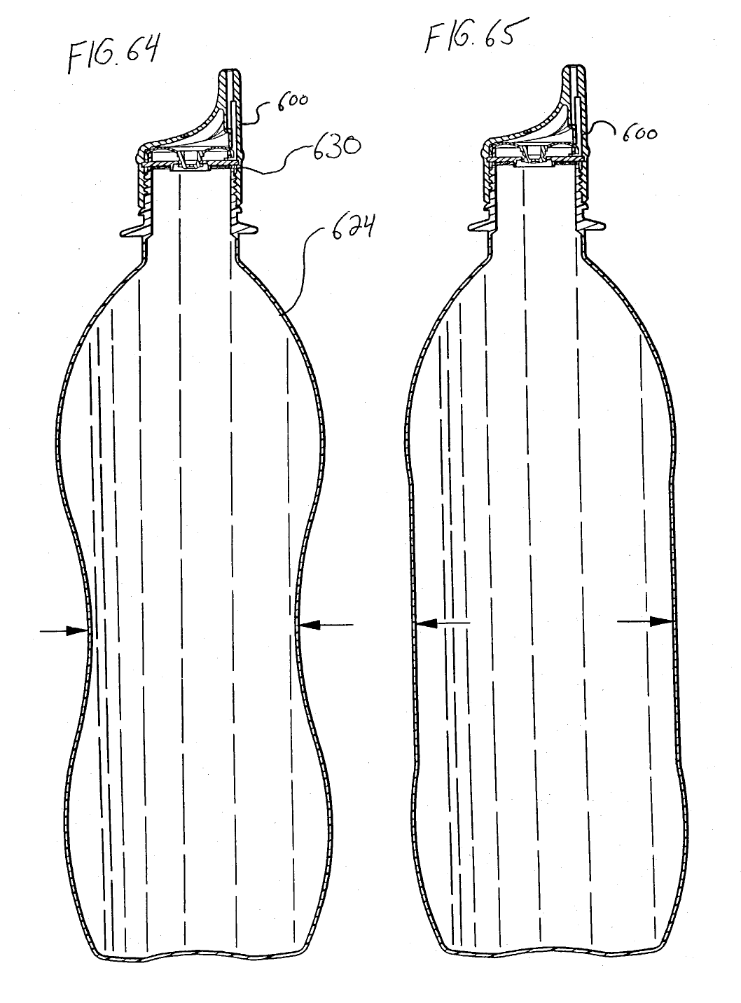

Another embodiment of a valve according to the present invention is shown in FIGS. 60-65 wherein the valve is generally shown by reference numeral 600. In this embodiment, the valve 600 includes a housing 602. The housing 602 generally includes a port member 604 which defines an outer opening 606. The housing 602 may further include a base member 608 having an inner opening 610. The housing 602 generally defines at least a portion of a passageway 612 between the outer opening 606 and the inner opening 610. A first chamber 609 is formed within the housing 602, and preferably, the housing 602 includes a vent 611 which vents the chamber 609 to maintain it at ambient pressure.

In this embodiment, the housing 602 includes an annular wall 614. The annular wall 614 preferably includes internal threads 616. Generally, the valve 600 of the present invention will be used in conjunction with a fluid container 618. The fluid container 618 preferably includes external threads 620 which cooperate with the threads 616 of the valve 600. The fluid container 618 also preferably includes a stop detail 622 which stops the annular wall 614 from being over tightened and moving too far down on to the fluid container 618.

The valve 600 generally includes a member 624. The member 624 is generally a flexible member associated with the housing as depicted in FIG. 60. The member preferably includes a flexible diaphragm 625. The member 624 of this embodiment preferably forms a passageway 612 between itself and the base member 608. The member 624 may have a connected or integrally formed stop member 626. The stop member 626 preferably includes a plug or sealing member 628. The stop member 626 extends through the inner opening 610, and the sealing member 628 forms a fluid tight seal with the opening when the valve 600 is in a closed position.

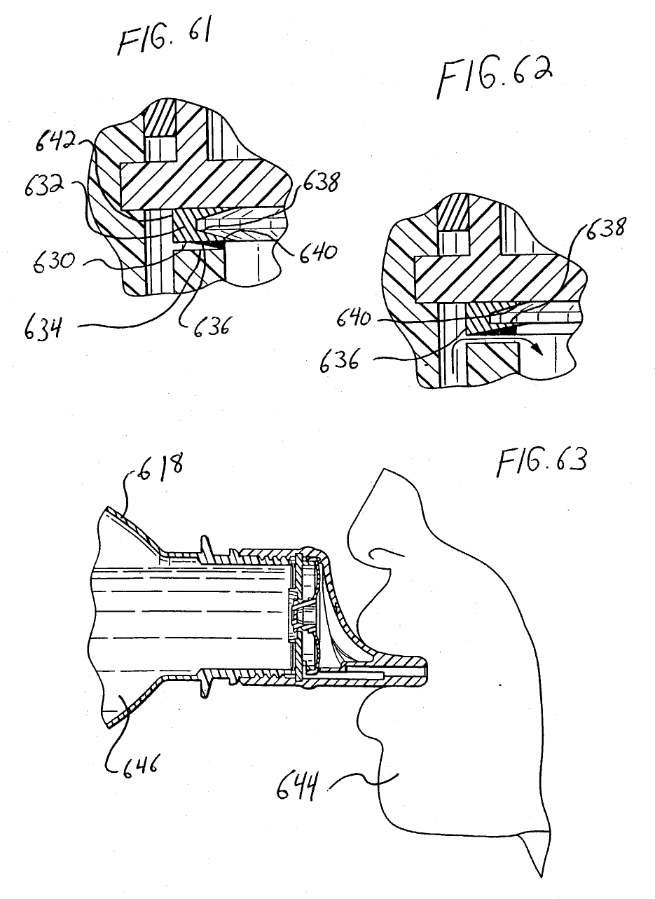

In this embodiment, the valve 600 includes a lip seal vent 630 as shown in detail in FIGS. 61 and 62. The vent 630 is operably associated with the housing 602, and preferably includes a flexible vent member 632. The vent member 632 is preferably attached to the housing 600. When the valve 600 is fully seated onto the fluid container 618, the vent member 632 contacts a lip 634 of the fluid container 618. When the valve 600 is fully seated onto the fluid container 618, preferably a space is formed adjacent to the vent 630. The space is exposed to ambient pressure, and therefore exposes a back or exterior surface 636 of the vent member 632 to ambient pressure. A front, or interior surface 638, of the vent 630 is exposed to the interior of the fluid container 618. The front surface 638 is preferably in a generally “U” or “V” shape. The vent member 632 preferably includes arms 640 which extend towards the interior of the fluid container 618, and a base 642, which generally forms the back surface 636. One of the arms 640 is generally bonded or integrally formed with the housing 602. When the valve 600 is fully seated onto the container 618, another arm 640 is biased to contact the lip 634 of the container 618 by the resilient nature of the flexible member 632.

In the valve 600 of the present embodiment, activation of the valve 600 from a closed position to an open position is based on pressure differentials which apply forces to different parts of the valve 600. Ambient pressure outside of the container 618 is referred to as a first pressure P1, or index pressure. The first pressure P1 acts on the exterior surface 636 of the vent 630. The first pressure P1 also is present in the chamber 609, and acts on the flexible member 624. Passageway 612 is at a second pressure P2. When the valve is not in use, and is in a closed position, the passageway 612 is generally at ambient pressure. Generally this means a user 644 is not sucking, or otherwise applying pressure reducing suction, to the outer opening 606. The fluid container 618 is at a third pressure P3. The pressure within the fluid container 618 varies depending on what fluid is in the container 618 as discussed above.

The deflectable member 624 is subject to biasing forces which keep it in a first position wherein the valve is in a closed position. The biasing forces generally include a force provided by the second pressure P2 in passageway 612, by a resilient force associated with the structure of the deflectable member 624, and by the third pressure P3, which generally acts on the sealing member 628 from inside the fluid container.

When a user 644 applies a suction force to outer opening 606, the second pressure P2 within the passageway 612 is reduced. The reduction of the second pressure P2 allows the first pressure, or index pressure, to overcome the remaining biasing forces which keep the deflectable member 624 in the first closed position. The deflectable member 624 then moves to a second position, wherein the valve is open, allowing fluid 646 to flow from the fluid container 618 through the inner opening 610 into the passageway 612, and out of the valve 600 through the outer opening 606. It is understood that a second position is not one particular position, but rather any position wherein the deflectable member 624 is in a position such that the valve 600 is open. When the suction force to the outer opening 606 is terminated, the valve 600 again closes. As previously discussed with regard to earlier embodiments, the passageway 612 preferably is formed such that the surface tension of the fluid prevents any fluid 646 from escaping through the outer opening 606 once the suction force is terminated.

In this embodiment, the vent 630 is also opened in response to pressure differentials. The vent 630 is preferably a one way vent which only allows air to enter the fluid container 618 from the surrounding environment when the pressure inside the container 618 is less than the first pressure P1. The vent 630 does not allow gas or fluid to escape from the container 618. A minimum activation pressure difference is generally required to overcome biasing forces within the vent 630 structure. Therefore, the pressure outside the container 618 may be slightly greater than the pressure within the container 618, yet the vent 630 will remain closed until the minimum activation pressure difference is attained. When the pressure inside the fluid container 618 is substantially equal to or greater than the pressure outside the container 618, the vent 630 remains closed.

The lip seal vent 630 is shown in its closed and opened positions in FIGS. 61 and 62. As discussed, the closed position is maintained when the pressure within the fluid container 618 is substantially equal to or greater than the pressure pushing on the back surface 642 of the vent 630. The substantially equal or greater pressure within the container 618 pushes against the front surface 638 of the vent 630. Here, one of the arms 640 is bonded to the valve 630, and the other arm 640 is kept in contact with the lip 634 of the container 618 by the fluid container pressure, and also by a biasing force associated with the resilient nature of the material used for the vent member 632.

When the pressure outside of the fluid container is greater than the pressure within the fluid container, the vent 630 is pushed open as indicated in FIG. 62. The arm 640 which was in contact with the lip 634 is moved, and air enters the fluid container 618. The reduction of pressure within the fluid container 618 is generally caused by a user activating the valve 600 and removing some of the fluid 646 contained therein. The vent 630 preferably opens while the fluid 646 is being removed, and remains open until the pressure within the fluid container 618 has been raised to a point such that it is at least substantially equal to the pressure outside of the container 618.

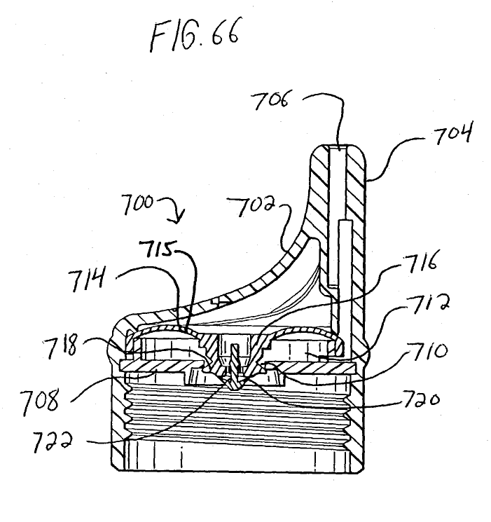

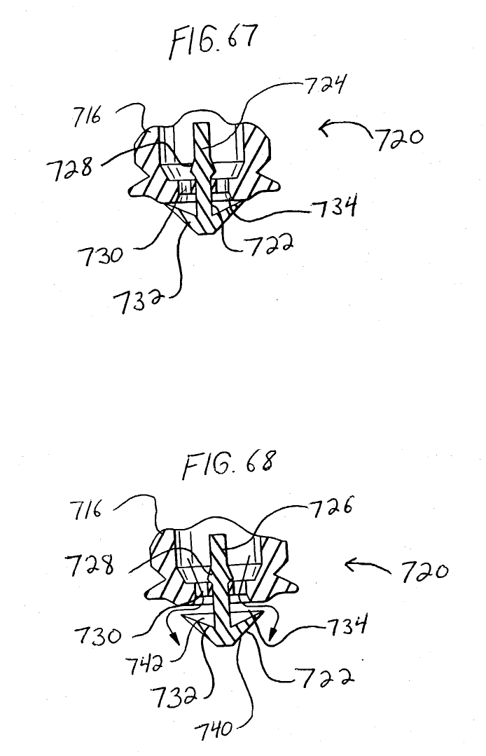

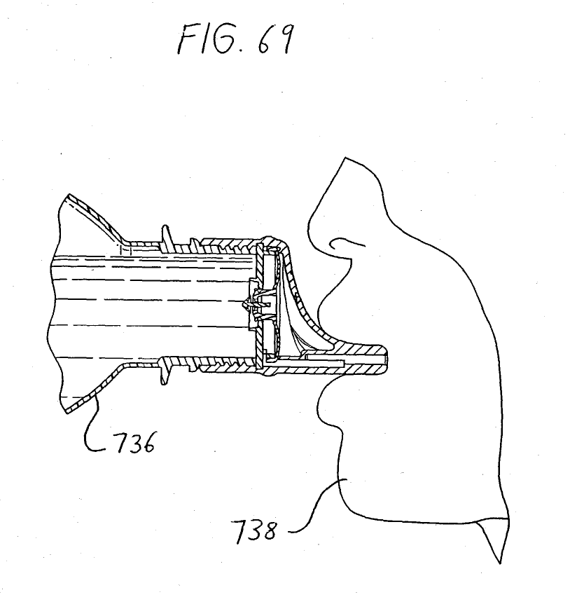

Use of the valve 600 with the vent 630 as disclosed in this embodiment makes the valve 600 particularly useful in dispensing fluid from bottles which are commonly used to store beverages. One example of a commonly used container is a blow molded bottle made from polyester, polyethylene, or other blow molded polymers in which soda pop, water, or other beverages are contained. These types of containers are semi-rigid in that the sides can be indented with a relatively small amount of force, but have a tendency to spring back to their original shape. Therefore, when a vent is not used, and the pressure within the container is reduced relative to the outside pressure, the fluid container 624 will tend to indent as shown in FIG. 64. However, use of a valve 600 having a vent 630 according to the present embodiment allows the pressure within the container 624 to be maintained at a level substantially equal to the outside pressure, providing a force which maintains the shape of the fluid container 624 as shown in FIG. 65, or at least restores the container 624 to its original shape as the vent 630 makes the pressures inside and outside of the container substantially equal.

In addition, use of the valve 600 with the vent 630 according to this embodiment prevents the undesirable suck back force discussed above, and provides a constant flow rate of fluid through the valve 600.

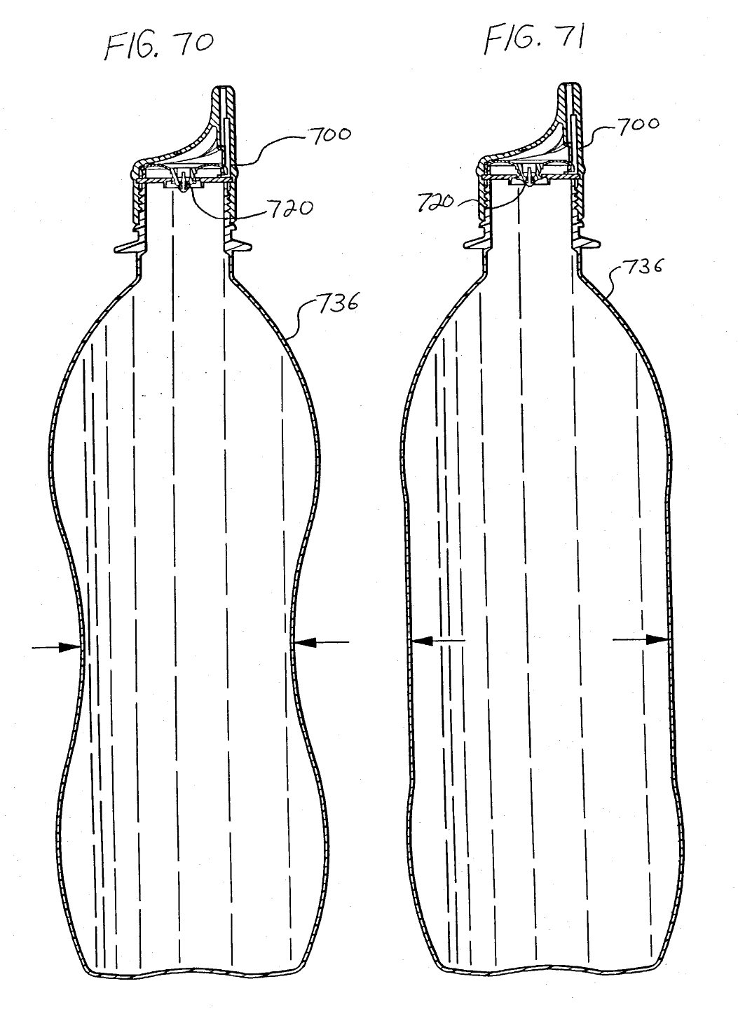

Another embodiment of the present invention is shown in FIGS. 66-71. The valve is generally represented by reference numeral 700. The valve 700 generally has a housing 702. The housing 702 generally includes a port member 704 which defines an outer opening 706. The housing 702 generally includes a base member 708 having an inner opening 710. The housing generally defines at least a portion of a passageway 712 between the outer opening 706 and the inner opening 710.

The valve 700 generally includes a deflectable member 714. The deflectable member 714 preferably includes a diaphragm 715. The member 714 of this embodiment defines a portion of a passageway 712 between itself and the base member 708. The deflectable member 714 preferably includes a connected or integrally formed stop member 716. The stop member 716 generally includes a sealing member 718 which fits within the inner opening 710.

Associated with, or incorporated to the stop member 716, is a vent 720. The vent 720 of this embodiment is shown in detail in FIGS. 67 and 68. The vent 720 preferably includes a vent member 722. The vent member 722 generally includes an attaching member 724 for attaching the vent member 722 to the stop member 716. The attaching member 724 extends into the stop member 716. The attaching member 724 includes an elongated stem 726 which is affixed to the stop member 716 by raised protuberances 728 on the elongated stem 726. The attaching member 724 remains stationary with respect to the stop member 716. The vent also includes a vent passageway 730 through the stop member 716 which provides a pathway for the traverse of air when the vent 720 is opened. The vent 720 generally also includes a sealing member 732 which is attached to the attaching member 724. The sealing member 732 is generally a bowl shaped member with the concave open end facing the stop member 716. The open end of the sealing member 732 includes a sealing ring 734 which is that portion of the sealing member 732 that contacts the stop member 716 when the vent 720 is in the closed position. The sealing ring 734 is preferably annularly arranged around the vent passageway 730.

As shown in conjunction with previously shown embodiments, here, activation of the valve 700 is again based on pressure differentials which apply forces which cause the valve 700 to move between a closed and an opened position. The diaphragm 714 is subject to an index pressure which tends to push down on its top surface when the valve is upright as shown in FIG. 66. The diaphragm is also subject to a first force which is operative to keep the stop member 716 within the inner opening 710, and the valve 700 closed. The first force is generally a composite force provided by different sources including a second pressure in passageway 712 pushing up on the diaphragm 714, a resilient force associated with the structure of the diaphragm 714, and a force from the pressure in the container 736 pushing up on the stop member 716.

The index pressure is ambient pressure which supplies a second force in a direction generally opposition to the direction of the first force, and tends to push the deflectable member 714 down when the pressure in passageway 712 is reduced. The pressure in passageway 712 is generally reduced by a user 738 applying a suction force to the outer opening 706, thereby creating a pressure differential between the index pressure and the second pressure. When the second pressure, or pressure within passageway 712, is sufficiently less than the index pressure, the second force overcomes the first force, and the valve 700 opens.

The vent 720 of this embodiment also functions based on pressure differentials. The sealing member 732 of the vent 720 is exposed to a pressure from within the fluid container 736 on an exterior surface 740, and the index pressure on an interior surface 742. When the pressure within the fluid container 736 is reduced, typically by removing a portion of the fluid contained therein through the valve 700, the index pressure pushing on the interior surface 742 through the vent passage 730, causes the sealing member 732 to flex, and the annularly arranged sealing ring 734 to break its seal with the stop 716. Air then flows into the fluid container 736 until the pressure within the fluid container 736 is substantially equal to the index pressure.

When the pressure within the fluid container 736 is substantially equal to, or greater than, ambient pressure, the force applied to an exterior surface 740 of the sealing member 732 which pushes against the stop member 716 creates or maintains the seal. In this way the vent 720 functions as a one way vent which only allows air or other gases into the fluid container 736, while retaining gases and liquids within the container.

Use of a valve having a vent as disclosed in this embodiment has benefits similar to those described in conjunction with other embodiments of a valve having a vent. These benefits include the reduction of indenting caused by pressure differences inside and outside of semi-rigid containers, and a constant flow rate of fluid out of the valve.

It will be understood that the invention may be embodied in other specific forms without departing from the spirit or central characteristics thereof. The present embodiments, therefore, are to be considered in all respects as illustrative and not restrictive, and the invention is not to be limited to the details given herein.

What is claimed is:

1. A valve comprising:
a member subject to a first force operative to keep said valve closed, said member being sensitive to an index pressure;
an outlet at a second pressure, said index pressure providing a second force in opposition to said first force when a differential between said second pressure and said index pressure is provided to said member, and opening the valve when said second pressure is sufficiently less than the index pressure to overcome the first force; and
a vent operably associated with the valve to maintain a fluid container to which the valve is operably connected at a pressure at least substantially equal to the index pressure.

2. The valve of claim 1 wherein said member provides said first force.

3. The valve of claim 1 wherein said valve closes under action of said second pressure when said index pressure provides said second force to said member of a magnitude less than that of said first force, and wherein said vent closes.

4. The valve of claim 1 wherein said valve closes under action of said second pressure when said second pressure on said member is substantially equal to said index pressure, and said vent closes.

5. The valve of claim 1 wherein said member includes a diaphragm.

6. The valve of claim 1 wherein said member including a stop.

7. The valve of claim 6 wherein said vent further comprises a vent member associated with said stop.

8. The valve of claim 7 wherein said vent further comprises a vent passageway exposed to said index pressure.

9. The valve of claim 8 wherein said vent member includes an attaching member and a sealing member, and wherein the sealing member flexes, opening said vent passageway allowing air at said index pressure to open the vent in response to a pressure differential between the index pressure and a reduced pressure within said fluid container.

10. The valve of claim 9, wherein the vent is a one way vent that allows air to flow into the fluid container.

11. The valve of claim 1 wherein said index pressure is ambient pressure.

12. A valve comprising:
a housing defining a passageway between an outlet opening and an inner opening, and a member being deflectable from a first position to a second position associated with said housing;
a stop connected to the deflectable member, wherein when the deflectable member is in the first position, the stop is in sealing contact with the inner opening to close the inner opening, and when the deflectable member is in the second position, the stop is spaced from the inner opening to open the inner opening; and
a vent operably associated with said stop where said vent comprises a vent passageway and a vent member.

13. The valve of claim 12 wherein said vent member has a sealing ring annularly arranged about the vent passageway wherein the vent member has an interior surface having a concave face and wherein the sealing ring is positioned along a rim of the vent member.

14. The valve of claim 13 wherein the vent member further comprises an interior and an exterior surface, and wherein when a force acting on the exterior surface is greater than a force acting on the interior surface the sealing ring seals the vent.

15. The valve of claim 14 wherein when the force acting on the interior surface is greater than the force acting on the exterior surface the vent is opened.

16. A flowable material delivery device comprising:
a first chamber under ambient pressure, the first chamber defining an outlet;
a second chamber containing a reservoir of flowable material which is vented to maintain the second chamber at a pressure at least substantially equal to ambient pressure;
an opening connecting the first chamber and the second chamber; and
a deflectable member positioned in the opening between said first chamber and said second chamber and moveable from a closed position to an open position when a pressure less than ambient pressure is applied to the first chamber wherein the flowable material flows from the second chamber through the outlet.

17. The flowable material delivery device of claim 16 wherein the second chamber is vented by a vent associated with the deflectable member.

18. The flowable material delivery device of claim 16 wherein the vent comprises a vent passageway and a vent member.

19. The flowable material delivery device of claim 18 wherein the vent member has a sealing ring annularly arranged about the vent passageway and an interior surface having a generally concave shape and wherein the sealing ring is arranged along a rim of the vent member.

20. The flowable material delivery device of claim 16 wherein the second chamber is a semi-rigid container.

21. The flowable material delivery device of claim 16 wherein the second chamber is a rigid container.
